(19) United States
(12) Patent Application Publication
(10) Pub. No.: US 2013/0014469 A1
(43) Pub. Date: Jan. 17, 2013

(54) Method For Facilitating Fluid Flow Through A Wall System

(71) Applicant: James K. Elwell, Sandy, UT (US)

(72) Inventor: James K. Elwell, Sandy, UT (US)

(21) Appl. No.: 13/182,677

(22) Filed: Jul. 14, 2011

(51) Int. Cl. E04B 1/70; E04B 2/00; B29C 39/00; E04B 2/02

(52) U.S. Cl. 52/741.4; 52/745.09; 52/745.05; 264/333

(57) ABSTRACT

A constructional building material, such as a brick, with at least one base section and a vane extending from the base section. The vane defines, at least in part, a volume of space within an envelope boundary that facilitates fluid flow, such as airflow, through a wall system formed at least in part from one or more constructional building materials. Adjacent vanes, either of the same constructional building material or of different constructional building materials, may operate to provide or define one or more common volumes of space and corresponding fluid flow channels and associated fluid flow paths. A wall system, formed in accordance with the present invention, allows fluid to pass from one side to the other through the wall system while also providing up to complete visual obstruction through the wall depending upon how the wall system is constructed. Additionally, the specific configuration of the vane of a constructional building material can function to provide visual obstruction by extending beyond its own envelope boundary to or beyond the envelope boundary of an adjacent constructional building material. The configuration of the vane in the constructional building material can vary and the wall system may be built from a plurality of constructional building material configurations. The constructional building material of the present invention may also be used in combination with tradition building materials to form a hybrid wall system.

### FIELD OF THE INVENTION

The present invention relates generally to constructional building materials, such as bricks, etc. used in architectural applications. More particularly, the present invention relates to a constructional building material for use in constructing walls, barriers or the like, and for facilitating fluid flow through a wall system.

### BACKGROUND OF THE INVENTION AND RELATED ART

Bricks and similar type building materials are common in constructing various structures, walls, barriers, etc. Historically, bricks were used as a means to build and physically support various type structures. Today bricks are widely used for architectural design and aesthetic purposes. Examples of modern brick use include interior decoration, house facades, and decorative walls. However, bricks are still a very commonly used building material used to construct walls and barriers. In addition to masonry type bricks, other materials, such as plastics, composites, and recycled materials are also used as suitable brick substitutes.

Bricks are usually combined together in a pattern and secured with mortar to form various structures, such as wall or barriers. One combination of brick use is known as a “screen wall,” which can serve various functions. For example, one function of a screen walls can be to at least partially conceal or hide spaces and objects from view with respect to an outside observer. Another function of screen walls can be to provide at least some airflow through the screen wall, such as for needed ventilation purposes. Common screen walls include those erected around dumpsters, mechanical equipment, furnaces, air conditioning units, etc. Screen walls can also make areas more private, such as a residential patio.

Screen walls generally have gaps to allow airflow to pass through the wall while still at least partially obstructing view of the object or space concealed on the opposing side of the wall. In the case of mechanical equipment, such as an air conditioner compressor, cold air is drawn through the gaps of the screen wall while the wall partially blocks both sight and sound to an outside observer.

Traditional screen walls, however, suffer from several limitations, and may thus be considered to be poorly built. For example, some conventional screen walls comprise gaps typically formed by spacing two adjacent bricks apart from one another to create what may be described as a hole through the wall. While air is able to flow through the wall, the formed gap or space in the wall provides a direct sight line through the wall. To increase the visual obstruction capacity of the wall, the number of gaps formed in the wall may be reduced, and/or their size may be reduced. However, both of these options negatively affects the airflow through the wall as there is either less spaces through which air may pass, or smaller spaces that function to restrict the airflow. In addition, the spaces provide a substantially laterally (i.e., horizontal) oriented line of sight allowing observers to see directly through the wall along a substantially horizontal axis or plane. A poorly designed screen wall is considered herein to be 1) one that provides sufficient airflow, but poor visual obstruction, 2) one that provides poor airflow, but sufficient visual obstruction, or 3) one that provides both poor airflow and poor visual obstruction. As visual obstruction is a relative term, it may be considered to mean the visual blocking of a line of sight through the wall structure that is substantially orthogonal to a vertical axis of the wall structure, or one that is within a range of ±20 degrees as measured from the horizontal. Of course this range may vary depending upon the particular size of bricks and construction practices employed to erect the wall. In essence, visual obstruction means not being able to see through the wall structure along, or within a certain number of degrees from, a substantially horizontal axis or plane that is orthogonal to the wall structure.

Conversely, although a traditional solid wall with little or no gaps will provide near complete visual obstruction, airflow through the wall is virtually eliminated, leaving only an air flow path over the wall or around the wall, if possible.

Restricted or reduced air flow caused by a solid wall or a poorly constructed screen wall can lead to air that is essentially trapped or caused to be stagnant inside the area enclosed by the wall. Depending upon the area and the object(s) contained by the wall, trapped or stagnant air can be problematic. For example, without sufficient airflow through the wall, machinery can be caused to perform at suboptimum levels, or odors may be caused to accumulate and intensify.

Additionally, with solid and poorly constructed screen walls, wind and other forces, which are often exerted against the exterior of a wall, can cause increased loading or pressure. For example, many outside walls are continuously subjected to dynamic loading as they are exposed to wind. A measure of the forces acting on the wall from the wind is known as wind loading. The greater the pressure or wind load, the more robust the wall needs to be to be in order to withstand the applied forces. The more robust the wall is, the more expensive it is to construct. Therefore, a desirable structure, such as a screen wall, would be constructed so as to reduce wind load, while still providing both enhanced visual obstruction and enhanced airflow over solid walls and poorly built screen walls.

### SUMMARY OF THE INVENTION

In light of the inherent problems associated with prior related constructional building materials, such as masonry bricks, the present invention seeks to overcome these by providing a constructional building material for use within a structure, such as a wall or other structure, wherein the constructional building material facilitates enhanced air or fluid flow and enhanced visual obstruction capabilities over prior related constructional building materials, and walls or other structures formed therefrom. This may be accomplished in many ways using many different designs of building materials. In addition, this may be accomplished within a single deep layer of building materials.

The present invention resides in a constructional building material comprising at least one base section and a vane of various designs extending outwards from the base section. In one exemplary embodiment, the present invention constructional building material comprises a first base section having a first surface, and a second surface substantially parallel to the first surface and defining a second plane; and at least one vane extending outward from the base section along a longitudinal axis, such that the cross-sectional area of the portion of the vane within the envelope boundary, is less than the cross-sectional area of the base section, whereby the vane operates to define a volume of space about the first vane surface and within the first and second planes.

Combining at least two constructional building materials formed after the manner of the present invention provides, at least in part, a wall system that facilitates fluid, such as air or water, to pass through the wall system, while also enhancing the visual obstruction capacity of the wall system. The wall system provides a fluid flow path or channel defined at least in part by the vanes of the at least two building materials. The vanes operate together to define a common volume of space and the fluid flow path. Additionally, the wall system can visually obstruct a line of sight substantially along a horizontal axis or plane, thus making the area contained within the wall structure difficult to view from without the wall structure. The configuration of the vane in the constructional building material can vary and the wall system may be built from a plurality of constructional building material configurations. The constructional building material of the present invention may also be used in combination with tradition building materials (e.g., bricks of conventional design) to form a hybrid wall system.

The present invention further resides in a method for facilitating fluid flow through opposing sides of a wall system. The method comprises obtaining at least two constructional building materials, each having at least one base section and at least one vane extending outward from the base section; and positioning the at least two constructional building materials in a manner so as to cause the at least two vanes to define a common volume of space and a fluid flow path that facilitates fluid flow through the opposing sides of the wall system.

The present invention further resides in a method for forming a constructional building material, comprising forming a first base section having a perimeter surface defining an envelope boundary extending along a longitudinal axis; forming at least one vane extending outward from the first base section along the longitudinal axis, the vane comprising a first vane surface; and configuring the vane such that a cross-sectional area of a portion of the vane within the envelope boundary is less than a cross-sectional area of the base section, wherein a volume of space is defined about the first vane surface and within the envelope boundary.

The present invention further resides in a method for forming at least a portion of a wall system having opposing sides, the method comprising obtaining a first constructional building material having at least one base section and at least one vane extending outward from the base section; obtaining a second constructional building material having at least one base section and at least one vane extending outward from the base section, the base sections of the first and second constructional building materials each having a perimeter surface defining an envelope boundary extending along a longitudinal axis; and forming a common volume of space defined, at least in part, by the vane of the first constructional building material and the vane of the second constructional building material, wherein the common volume of space defines, at least in part, a fluid flow channel that facilitates fluid flow through the wall system from one of the opposing sides of the wall system to the other of the opposing sides of the wall system along a fluid flow path.

The present invention further resides in a method for facilitating fluid flow through opposing sides of a wall system, the method comprising obtaining at least two constructional building materials configured to form at least a part of the wall system, each of the constructional building materials having a base section and a vane extending from the base section; and positioning the at least two constructional building materials in a manner so as to cause the vanes of the constructional building materials to at least partially define a common volume of space and a fluid flow path that facilitates fluid flow through the opposing sides of the wall system.

The present invention further resides in a method for forming at least a portion of a wall system having opposing sides, the method comprising obtaining a first constructional building material having at least one base section and at least two vanes extending outward from the base section, the base section of the first constructional building material having a perimeter surface defining an envelope boundary extending along a longitudinal axis, the at least two vanes forming a volume of space; obtaining a second constructional building material; and positioning the first and second constructional building materials adjacent one another, wherein the common volume of space defines, at least in part, a fluid flow channel that facilitates fluid flow through the wall system from one of the opposing sides of the wall system to the other of the opposing sides of the wall system along a fluid flow path.

### BRIEF DESCRIPTION OF THE DRAWINGS

The present invention will become more fully apparent from the following description and appended claims, taken in conjunction with the accompanying drawings. Understanding that these drawings merely depict exemplary embodiments of the present invention they are, therefore, not to be considered limiting of its scope. It will be readily appreciated that the components of the present invention, as generally described and illustrated in the figures herein, could be arranged and designed in a wide variety of different configurations. Nonetheless, the invention will be described and explained with additional specificity and detail through the use of the accompanying drawings in which:

FIG. 1A illustrates a front perspective view of the constructional building material in accordance with one exemplary embodiment of the present invention;

FIG. 1B illustrates a transverse cross section of the constructional building material of FIG. 1A taken along section A-A;

FIG. 1C illustrates a rear perspective view of the constructional building material of FIG. 1A;

FIG. 2A illustrates a constructional building material in accordance with another exemplary embodiment of the present invention;

FIG. 2B illustrates a transverse cross section of the constructional building material of FIG. 2A taken along section B-B;

FIG. 2C illustrates a top view of the constructional building material of FIG. 2A;

FIG. 3A illustrates a constructional building material in accordance with another exemplary embodiment of the present invention;

FIG. 3B illustrates a transverse cross section of the constructional building material of FIG. 3A taken along section C-C;

FIG. 4A illustrates a constructional building material in accordance with still another exemplary embodiment of the present invention;

FIG. 4B illustrates a rear perspective view of the constructional building material of FIG. 4A;

FIG. 4C illustrates a transverse cross section of the constructional building material of FIG. 4A taken along section D-D;

FIG. 5A illustrates a perspective view of a wall system constructed in accordance with one exemplary embodiment of the present invention, wherein the wall system comprises a plurality of constructional building materials formed after the manner of those illustrated in FIG. 1A;

FIG. 5B illustrates a front view of the wall system of FIG. 5A;

FIG. 5C illustrates a transverse cross section of the wall system of FIG. 5A taken along section E-E;

FIG. 5D illustrates a side view of the wall system of FIG. 5A;

FIG. 5E illustrates a rear view on the wall system of FIG. 5A;

FIG. 6A illustrates a wall system constructed in accordance with another exemplary embodiment of the present invention, wherein the wall system comprises a plurality of building materials formed after the manner of those illustrated in FIG. 1A;

FIG. 6B illustrates a transverse cross section of the wall system of FIG. 6A taken along section F-F;

FIG. 7A illustrates a constructional building material in accordance with still another exemplary embodiment of the present invention;

FIG. 7B illustrates a transverse cross section of the constructional building material of FIG. 7A taken along section G-G;

FIG. 8A illustrates a wall system constructed in accordance with another exemplary embodiment of the present invention, wherein the wall system comprises a plurality of building materials formed after the manner of those illustrated in FIG. 7A;

FIG. 8B illustrates a cross section of the wall system of FIG. 8A taken along section H-H;

FIG. 9A illustrates a constructional building material in accordance with still another exemplary embodiment of the present invention;

FIG. 9B illustrates a transverse cross section of the constructional building material of FIG. 9A taken along section I-I;

FIG. 10A illustrates a wall system constructed in accordance with another exemplary embodiment of the present invention, wherein the wall system comprises a plurality of building materials formed after the manner of those illustrated in FIG. 9A;

FIG. 10B illustrates a transverse cross section of the wall system of FIG. 10A taken along section J-J;

FIG. 11A illustrates a constructional building material in accordance with still another exemplary embodiment of the present invention;

FIG. 11B illustrates a transverse cross section of the constructional building material of FIG. 11A taken along section K-K;

FIG. 12A illustrates a wall system constructed in accordance with another exemplary embodiment of the present invention, wherein the wall system comprises a plurality of building materials formed after the manner of those illustrated in FIG. 11A;

FIG. 12B illustrates a transverse cross section of the wall system of FIG. 12A taken along section L-L;

FIG. 13A illustrates a constructional building material in accordance with still another exemplary embodiment of the present invention;

FIG. 13B illustrates a top view of the constructional building material of FIG. 13A;

FIG. 14A illustrates a constructional building material in accordance with still another exemplary embodiment of the present invention;

FIG. 14B illustrates a top view of the constructional building material of FIG. 14A;

FIG. 15A illustrates a perspective view of a wall system constructed in accordance with another exemplary embodiment of the present invention, wherein the wall system comprises a two-part design with plurality of building materials formed after the manner of those illustrated in FIG. 13A and FIG. 14A;

FIG. 15B illustrates a transverse cross section of the wall system of FIG. 15A taken along section O-O;

FIG. 16A illustrates a front view a wall system constructed in accordance with another exemplary embodiment of the present invention, wherein the wall system comprises a two-part design with plurality of building materials formed after the manner of those illustrated in FIG. 1A and FIG. 13A;

FIG. 16B illustrates a transverse cross section of the wall system of FIG. 16A taken along section P-P;

FIG. 17 illustrates a perspective view of a wall system constructed in accordance with another exemplary embodiment of the present invention, wherein the wall system comprises a plurality of constructional building materials formed after the manner of the present invention combined with building materials of a more traditional design, namely standard bricks (e.g., masonry bricks that have a uniform cross-section along a longitudinal axis);

FIG. 18A illustrates a constructional building material in accordance with still another exemplary embodiment of the present invention;

FIG. 18B illustrates a front view of the constructional building material of FIG. 18A;

FIG. 19A illustrates a wall system constructed in accordance with another exemplary embodiment of the present invention, wherein the wall system comprises a plurality of building materials formed after the manner of those illustrated in FIG. 18A;

FIG. 19B illustrates a front view of the wall system of FIG. 19A;

FIG. 20 illustrates a constructional building material in accordance with still another exemplary embodiment of the present invention;

FIG. 21 illustrates a wall system constructed in accordance with another exemplary embodiment of the present invention, wherein the wall system comprises a plurality of building materials formed after the manner of those illustrated in FIG. 20;

FIG. 22A illustrates a constructional building material in accordance with still another exemplary embodiment of the present invention;

FIG. 22B illustrates a transverse cross section of the constructional building material of FIG. 22A taken along section V-V;

FIG. 23A illustrates a constructional building material in accordance with yet another exemplary embodiment of the present invention;

FIG. 23B illustrates a transverse cross section of the constructional building material of FIG. 23A taken along section W-W;

FIG. 24A illustrates a constructional building material in accordance with another exemplary embodiment of the present invention;

FIG. 24B illustrates a transverse cross section of the constructional building material of FIG. 24A taken along section X-X;

FIG. 25A illustrates a wall system constructed in accordance with another exemplary embodiment of the present invention, wherein the wall system comprises a plurality of building materials formed after the manner of those illustrated in FIG. 24A; and

FIG. 25B illustrates a transverse cross section of the wall system of FIG. 25A taken along section Y-Y.

### DETAILED DESCRIPTION OF EXAMPLE EMBODIMENTS

The following detailed description of exemplary embodiments of the invention makes reference to the accompanying drawings, which form a part hereof and in which are shown, by way of illustration, exemplary embodiments in which the invention may be practiced. While these exemplary embodiments are described in sufficient detail to enable those skilled in the art to practice the invention, it should be understood that other embodiments may be realized and that various changes to the invention may be made without departing from the spirit and scope of the present invention. Thus, the following more detailed description of the embodiments of the present invention is not intended to limit the scope of the invention, as claimed, but is presented for purposes of illustration only to describe the features and characteristics of the present invention, and to sufficiently enable one skilled in the art to practice the invention. Accordingly, the scope of the present invention is to be defined solely by the appended claims.

The following detailed description and exemplary embodiments of the invention will be best understood by reference to the accompanying drawings, wherein the elements and features of the invention are designated by numerals and letters throughout.

At the outset, the term “constructional building material” shall be understood to mean a brick or brick-like structure that can be used in combination with like brick or brick-like structures (or even with dissimilar brick or brick-like structures if desired) in the construction of a barrier, wall, support, or other similar structure.

The term “base section” shall be understood to mean the primary load bearing portion(s) of the constructional building material, and the portion(s) that serves as the primary base building structure for stacking a plurality of building materials (with or without the use of mortar or other similar setting binder). The base section may comprise a block-like structure, such as a cube or elongated cube (cuboid) that has at least two substantially parallel surfaces, or may comprise a block-like structure with at least two non-linear or curved surfaces, wherein, when stacked, a surface of one base structure matches or mates with a surface of a second base structure.

The term “envelope boundary” shall be understood to mean the imaginary boundary surrounding or enveloping the constructional building material along a longitudinal axis of the constructional building material, and that extends between and beyond the end-most surfaces of the constructional building material along the longitudinal axis. The envelope boundary is defined by the perimeter surface(s) of the base section(s), wherein the envelope boundary lies along one or more points defined by the largest cross-sectional area of the base section(s) taken orthogonal to the longitudinal axis.

The term “vane” shall be understood to mean a structure that extends outward from one or more base sections in one or more directions, and that provides at least one surface that defines, at least in part, one or more volumes of space about the surface or surfaces of the vane. Although portions of the vane may extend beyond the envelope boundary in some embodiments, each vane comprises a portion within the envelope boundary that has a cross-sectional area that is less than the cross-sectional area of one or more base sections, the cross-sectional areas being taken orthogonal to the longitudinal axis of the constructional building material. Thus, the vane defines, at least in part, a volume of space and a fluid flow path or channel about the one or more vane surfaces.

The present invention provides several significant advantages over prior related constructional building materials. First, in some exemplary embodiments, the present invention provides a unique brick or brick-like structure designed to both increase fluid flow (e.g., air, water, etc.) through a formed wall system or other structure, and to provide up to complete visual obstruction through the wall system or other structure. The present invention constructional building material facilitates passage of fluids through the opposing sides of a formed wall system (i.e., from one side to the other). The present invention constructional building material also provides enhanced visual obstruction through the portion of the wall or other structure formed with the present invention constructional building material. Indeed, in some exemplary embodiments line of sight along an axis orthogonal to the vertical axis of the wall structure is inhibited, keeping observers from viewing the inner area bounded by the wall structure. Third, the present invention constructional building material provides reduced wind loading or pressure on a wall system formed at least partially from the present invention constructional building material, thus allowing thinner, yet stronger, and more architecturally pleasing structures to be designed and built. Fourth, the present invention allows for controlled directional fluid flow through the wall structure by defining specific fluid flow paths using and positioning a combination of constructional building materials and their associated vanes. A user can dictate the directional fluid flow through the wall by selecting building materials having a desired configuration, particularly a desired vane configuration, and arranging these into a strategic assembly or formation.

One noteworthy advantage or benefit of a wall system formed at least in part from some of the embodiments of the present invention building materials is that the resulting wall system (or rather the part formed with the present invention building materials if not formed entirely from the present invention building materials) may be constructed only one layer deep or thick (e.g., a single layer deep of stacked building materials), while still providing for air flow through the wall system, as well as up to complete or total visual obstruction. In other words, unlike prior related wall systems and methods for forming these, it is not necessary in some embodiments of the present invention to require two or more layers deep or thick of stacked building materials in a formed wall system to obtain the benefits of up to complete visual obstruction coupled simultaneously with fluid flow through the wall system. This is a significant advantage in that a brick wall having two or more layers thick may be formed with a space between the layers providing the same visual obstruction and air passage through the wall system. However, as the wall system is multiple layers thick, at least twice as many bricks and at least twice as much labor would be required to construct the wall system, thus greatly elevating the overall cost of constructing the wall system. In addition, the formed spaces would be very difficult to access and clean, while being easy for dirt and other debris to accumulate therein.

In addition to the many functional advantages listed above, the present invention allows users to construct an aesthetically pleasing architectural structure.

Each of the above-recited advantages will be apparent in light of the detailed description set forth below, with reference to the accompanying drawings. Indeed, one skilled in the art will appreciate that other advantages may be realized, other than those specifically recited herein, upon practicing the present invention.

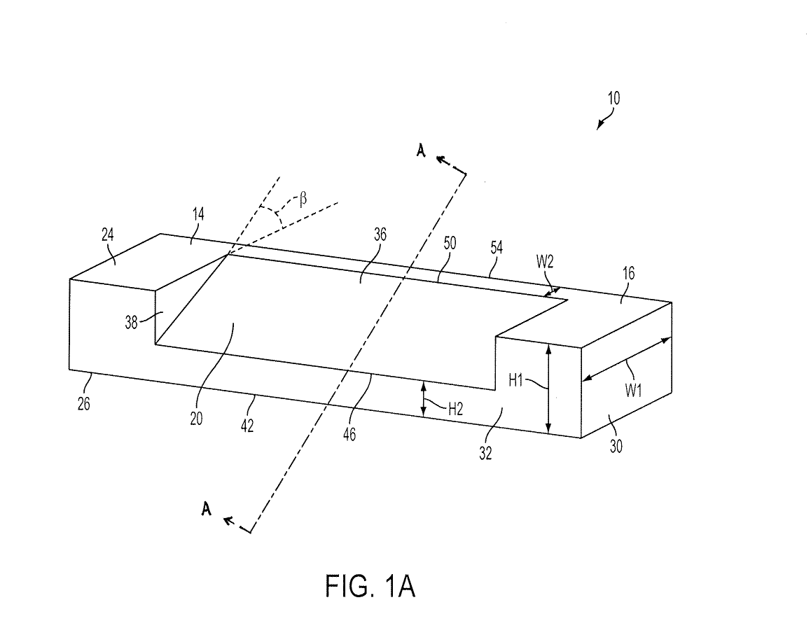

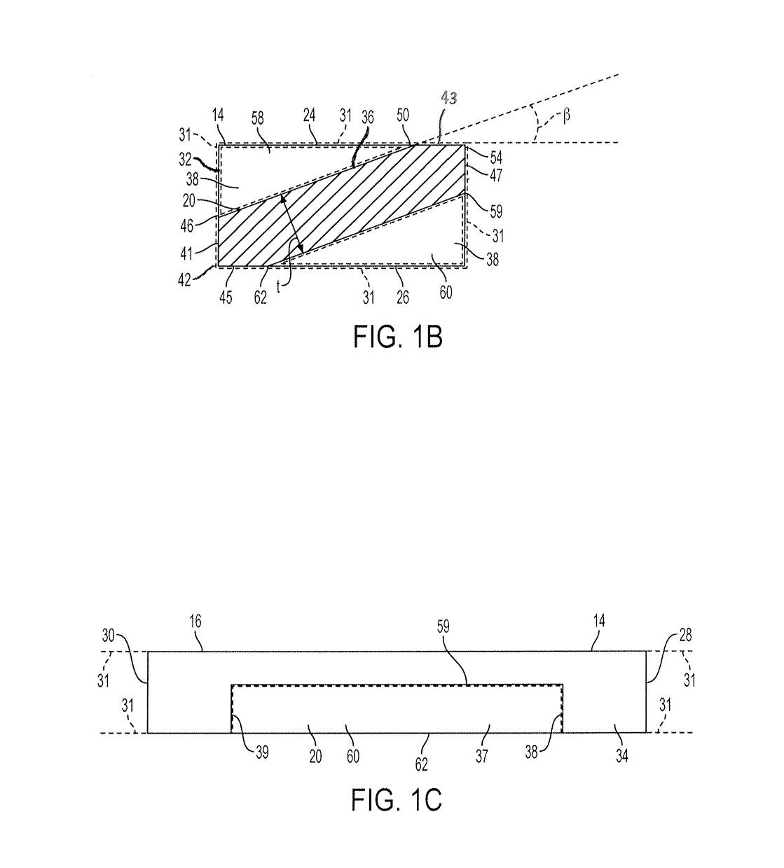

With specific reference to FIG. 1A-FIG. 1C, illustrated is a constructional building material 10 according to an exemplary embodiment of the present invention, wherein the building material 10 comprises a first base section 14 and a second base section 16, each defining an upper surface 24 and a lower surface 26. The first surface 24 and the second surface 26 are parallel or substantially parallel to one another. The first and second base sections 14 and 16 further define a front surface 32 and a rear surface 34. The first base section 14 comprises an intermediate surface 38 and a first end surface 28. The second base section 16 comprises an intermediate surface 39 and a second end surface 30. The first and second base sections 14 and 16 may comprise an elongated cube or block-like configuration as shown herein, or another suitable configuration, wherein the height H1 and the width W1 can be varied as will be appreciated by one skilled in the art.

The first and second base sections 14 and 16 are the primary support structures designed to be the primary load-bearing portions of the building material 10. In other words, the first and second base sections 14 and 16 are the primary portions of the building material 10 stacked against adjacent base portions of similar or conventional building materials during formation of a wall or other structure. For example, the upper and lower surfaces 24 and 26 of the building material 10 in most embodiments will receive the binding material (e.g., mortar) and serve as the building blocks of the building material 10 in the formation of at least a portion of a wall or other structure.

An imaginary envelope boundary 31 envelopes the constructional building material 10 and extends along a longitudinal axis between and beyond the end most surfaces 28 and 30 of the construction brick material 10. As illustrated in FIG. 1B by the dotted lines, the envelope boundary 31 surrounds or envelopes the first surface 24, second surface 26, front surface 32 and rear surface 34 of the first base section 14. Likewise, the boundary 31 surrounds and envelopes the similar surfaces found on the second base section 16. FIG. 1B further illustrates that the cross-sectional area of the envelope boundary 31 is defined by the largest cross-sectional area of the first base section 14 as taken orthogonally (e.g. perpendicular) to the longitudinal axis of the building material 10. Additionally, as FIG. 1C illustrates, the envelope boundary 31 may be thought of as extending in both directions beyond the end most surfaces 28 and 30 of the base sections 14 and 16 and along the longitudinal axis of the building material 10

Referring back to FIGS. 1A-1C, the constructional building material 10 further comprises a vane 20 extending between the first and second base sections 14 and 16 designed to define, at least in part, a volume of space and a fluid flow path that provides the building material 10 with a structural component that facilitates airflow through a wall or other structure formed at least in part by one or more building materials 10, as described in more detail below. In other words, volumes of spaces 58 and 60 are defined when the cross-sectional area of the vane 20, taken within the envelope boundary 31, is less than the cross-sectional area of the base section 14 (e.g., such as that taken along the intermediate surfaces 38 and 39). If a vane 20 has any portion that extends outside the envelope boundary 31, as will be discussed below in detail, then the cross-sectional area of the portion that extends beyond the envelope boundary 31 will be excluded when relating the cross-sectional area of the vane to the base sections to define the volumes of space. Further, it will be understood that in the event the cross-sectional area of the vane 20, within the envelope boundary, is equal to the cross-sectional of the base section 14, then no volumes of space will exist or be defined.

In the embodiment shown, the vane 20 comprises an upper surface 36, and a lower surface 37 that is substantially parallel to the first surface 36. The structure of the vane 20 is such that it extends outward and away from the first base section 14 and towards, and in this case between, the second base section 16 along a longitudinal axis and is orientated on an incline with respect to the upper and lower surfaces 24 and 26 of the base section 14. Thus, the length of the vane 20 can be understood to mean, in some aspects, the distance the vane 20 extends outward from the first base section 14 before terminating. The first surface 36 of the vane 20 is shown as extending on an incline at an angle β, as measured from the upper surface 24. The first surface 36 of the vane 20 extends from a location about the first surface 24 offset a distance from the rear surface 34, and towards the second surface 26 without extending between these. In other words, as shown, the first surface 36 of the vane 20 can be configured to extend from the upper surface 24 to the front surface 32, without extending entirely between the upper and lower surfaces 24 and 26. In this configuration, transition surfaces 41 and 43 are provided for and defined.

Likewise, the lower surface 37 of the vane 20, being parallel or substantially parallel to the upper surface 36, is shown extending on an incline from a location about the rear surface 34 offset a distance from the upper surface 24 towards the lower surface 26. In other words, as shown, the lower surface 37 of the vane 20 can be configured to extend from the rear surface 34 to the lower surface 26 without extending entirely between the upper and lower surfaces 24 and 26. In this configuration, transition surfaces 45 and 47 are provided for and defined. In other embodiments, as will be described below, the vane surface 36 may extend from the upper surface 24 to the lower surface 26.

In the embodiment shown in FIGS. 1A-1C, the vane 20 extends between first and second base sections 14 and 16 to make up the structural components of the building material 10. In this configuration, the vane 20 also operates to define, at least in part a volume of space 58, about the vane surface 36 within the envelope boundary 31. The vane 20 further operates to define, at least in part, a volume of space 60 about the lower vane surface 37 within the envelope boundary 31. Volumes of spaces 58 and 60 define, at least partially, fluid flow paths about the upper and lower vane surfaces 36 and 37 of the vane 20 that facilitate the passage and flow of fluid through a wall or other structural system formed at least in part by the building material 10.

As can be seen, the upper and lower surfaces 36 and 37 of the vane 20 are out of plane with the upper and lower surfaces 24 and 26 defined by the first and second base sections 14 and 16, by the angle β. This angle may vary as desired, as will be appreciated by one skilled in the art. As the surfaces of the vane 20 are out of plane with the surfaces of the base sections 14 and 16 (e.g., oriented on an incline with respect to these), and as the vane 20 comprises a thickness t that is less than the height H1 of the base sections, and as the cross-sectional area of the portion of the vane within the envelope boundary is less than the cross-sectional area of the base sections, as discussed above, intermediate surfaces 38 and 39 are provided, which surfaces also function to assist in defining the volume of space 58. The volumes of space 58 and 60 created by the upper and lower vane surfaces 36 and 37 are separated from one another by the vane 20.

The vane 20 may further comprise multiple edges that make up and define the general configuration of the vane 20, such as edges 42, 46, 50, 54, 59, and 62. The location of these edges may vary depending upon the configuration of vane desired. For example, depending upon the angle β, the edges may be located at various locations along the respective surfaces of end sections, wherein the height H2 and the width W2 may be caused to be different distances than shown in the drawings. Again, various aspects of the vane (and of the base sections) may be different than shown here, as will be shown below, and as will be appreciated by those skilled in the art. Indeed, other exemplary embodiments of building materials formed in accordance with the present invention are described below.

In one aspect, the building material can comprise a masonry type brick or brick-like structure (e.g., one made from clay, clay composites, ceramics, stone, shale, soft slate, calcium silicate, concrete, shaped from quarried stone, etc.). In another aspect, the building material can comprise a synthetic or plastic brick or brick-like structure. In still another aspect, the building material may comprise a hybrid of different types of materials, for example, one comprised of masonry type base section(s) with a plastic or composite vane. Of course, the building material may be comprised of other available materials, as will be appreciated by those skilled in the art, thus those listed here should not be construed as being limiting in any way.

Further, while the constructional building material may be a single (e.g., monolithic) structure, the constructional building material may also be comprised of independent components that fit or otherwise operate with one another (e.g., modular components), which may be removable with one another. For example, the first and second base sections may be independent of the vane component, wherein the vane may be coupled to or otherwise secured to or with one or more base sections.

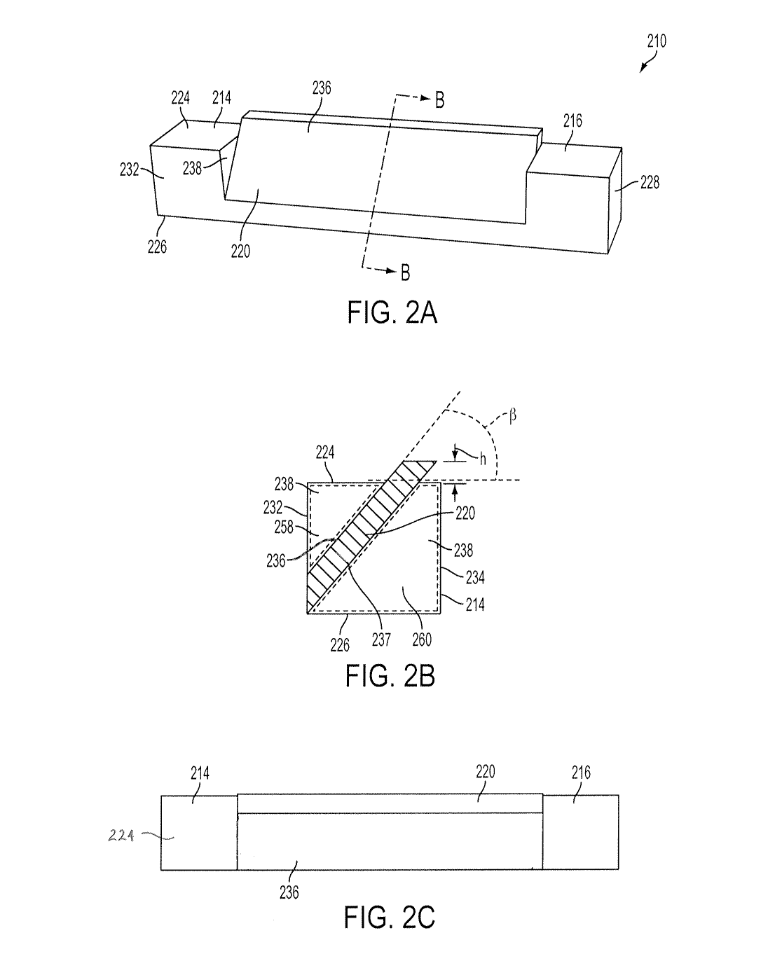

FIGS. 2A-2C illustrate a constructional building material in accordance with another exemplary embodiment of the present invention. In this embodiment, the constructional building material 210 comprises first and second base sections 214 and 216 similar to those described above, these defining, at least in part, an upper surface 224, a lower surface 226, a front surface 232, a rear surface 234, an intermediary surface 238 and an end surface 228. An imaginary envelope boundary (not shown, but similar to the one discussed above) surrounds or envelopes the upper surface 224, lower surface 226, front surface 232 and rear surface 234. The imaginary envelope boundary can also be thought to extend beyond the end most surfaces of the base sections of the building material 210, along a longitudinal axis. The building material further comprises a vane 220 extending between first and second base sections 214 and 216 and having opposing upper and lower vane surfaces 236 and 237 that are parallel or substantially parallel to one another, also similar to the embodiment described above.

However, in this particular embodiment, the vane 220 extends upwards a distance h beyond the upper surface 224 of the first base section 214. Further, the vane 220 extends outside of the envelope boundary. The distance h may vary upon need or desire. In one exemplary embodiment, though not limiting, the distance h may correspond to the thickness of a layer of binding material (e.g., mortar) to be placed between two like building materials 210 stacked together. The vane 220, and particularly the portion extending upward beyond the upper surface 224, may function to further obstruct visibility through two like building materials 210 stacked together. For instance, in the event two constructional building materials 210 formed in accordance with the embodiment shown in FIGS. 2A-2C were stacked on top of one another, with a binding material (mortar) between them, line of sight through the resulting structure along an axis orthogonal or substantially orthogonal to the front surfaces of the structure would be blocked as long as the distance h the vane extends upwards beyond the upper surface 224 matched or exceeded the thickness of the mortar between the stacked building materials. This feature provides increased functionality above the constructional building material described above and shown in FIGS. 1A-1C. In that embodiment, referring back, stacking two like building materials 10 on top of one another, with mortar between them, would leave a gap between the two adjacent vanes that would provide visibility directly through the resulting structure, and particularly along a line of sight orthogonal or substantially orthogonal to the front surfaces of the stacked structures. On the other hand, with the embodiment shown in FIGS. 2A-2C, the lower vane, with its extended portion, would essentially close what would otherwise be a similar gap, thus cutting off visibility through the resulting structure of two stacked constructional building materials between adjacent vanes. This is described in further detail below.

Referring back to FIGS. 2A-2C, the vane 220 is configured to extend upward and away from the front surface 232 at an inclined having an angle β towards and through the upper surface 224. The angle of the vane 220, represented by the angle β, may vary according to design preferences, or as needed, as will be appreciated by those skilled in the art. In addition, as is shown here, the vane 220 is not limited to being constrained within the planes defined by the upper and lower surfaces 224 and 226, respectively, but may extend beyond one or both of these surfaces. Additionally, while the vane 220 may extend beyond the upper and lower surfaces 224 and 226 and thus beyond the envelope boundary, it may be contained within the planes defined by the front and rear surfaces 232 and 234, respectively, of the base sections 214 and 216. However, as will be described below and shown in other drawings, this is not to be limiting in any way. Similar to the embodiment described in FIGS. 1A-1C, the vane 220 provides two parallel surfaces that define, at least in part, volumes of space 258 and 260. These volumes of space 258 and 260 are further defined, at least in part, by the cross-sectional area of the vane 220, within the envelope boundary being less than the cross-sectional area of one of the base sections 214 or 216. In this embodiment, the cross-sectional area of the portion of the vane 220 compared to the cross-sectional area of at least one of the base sections 214 or 216, and used to define the volumes of space 258 and 260 within the envelope boundary, does not include any of the portion of the vane outside of the envelope boundary (e.g. that portion having a height h). Further, these volumes of space define, at least in part, a fluid flow path that facilitates airflow about the vane.

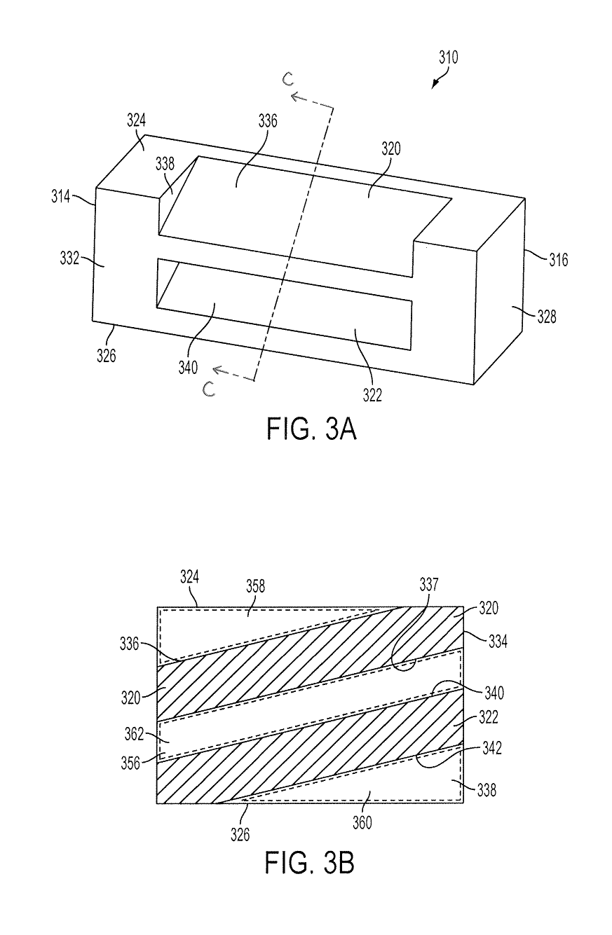

FIGS. 3A-3B illustrate another exemplary embodiment of a constructional building material in accordance with the present invention. In this embodiment, the constructional building material 310 comprises a first base section 314 and a second base section 316 similar to those discussed above, comprising or defining an upper surface 324, a lower surface 326, a front surface 332 and a rear surface 334 of the building material. An imaginary envelope boundary (not shown, but similar to those discussed above) surrounds or envelops the upper surface 324, lower surface 326, front surface 332 and rear surface 334, the imaginary envelope boundary also extending outwards beyond the end most surfaces of the base sections of the building material, along a longitudinal axis. The building material 310 further comprises end surfaces (see end surface 328), and intermediate surfaces (see intermediate surface 338) similar to those described above.

In this particular embodiment, the constructional building material 310 further comprises a plurality of vanes. Specifically, the building material 310 comprises a first vane 320 and a second vane 322, each of which may be configured similarly, and each of which may comprise upper and lower surfaces (see upper and lower surfaces 336 and 337 of the first vane 320, and upper and lower surfaces 340 and 342 of the second vane 322) similar to those described above. The first and second vanes 320 and 322 extend between the first and second base sections 314 and 316, and are vertically disposed relative to one another. The first and second vanes 320 and 322 are also configured to be parallel to one another, and function to define, at least in part, a plurality of volumes of space (see volumes 358, 360 and 362) that facilitate the flow of fluid about the surfaces of the vanes. Further, the volumes of space 358, 360 and 362 are in part defined by the combined cross-sectional areas of the portions of the vanes 320 and 322 within the envelope boundary being less than the cross-sectional area of one of the base sections.

With two or more adjacent vanes, the building material 310 further functions to define a fluid flow path 356, wherein air or other fluids may pass through the building material about the surfaces of the first and second vanes 320 and 322. It will be appreciated that the fluid flow path, or direction of fluid flow, may be manipulated by the configuration of the base section(s) and vane(s) of the building material.

The fluid flow path 356 is defined by the lower surface 337 of the first vane 320 and the upper surface 340 of the second vane 322, as shown. In this case, fluid is able to pass over these surfaces through the building material 310, thus allowing the building material to provide a ventilation function either alone or in combination with other similar or dissimilar building materials. Again, it will be recognized that the configuration and orientation of the base sections and vanes may be different than shown, and therefore the fluid flow path may be configured differently than as shown. For example, although the constructional building material embodiment of FIGS. 3A and 3B comprises a base section and vane configuration more similar to that shown in FIGS. 1A-1C, it could also comprise a vane configuration more similar to the embodiment shown in FIGS. 2A-2C. However, this is not intended to be limiting in any way.

Moreover, although not described in detail herein, it is contemplated that a single present invention building material can comprise any number of base sections and vanes, as will be appreciated by those skilled in the art. In addition, the building material may be configured to comprise similarly or differently configured vanes.

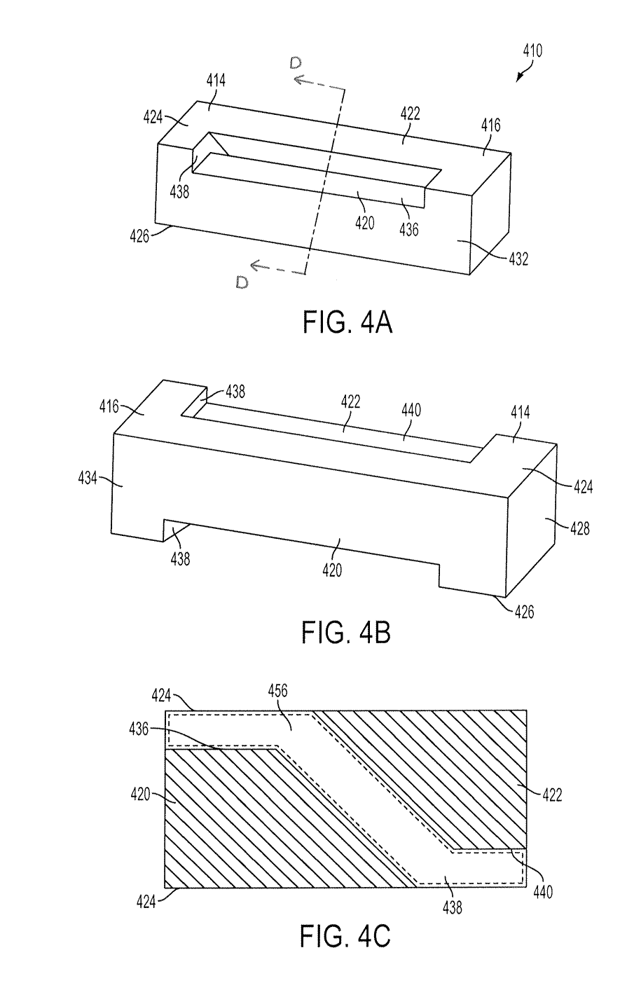

With reference to FIGS. 4A-4C, illustrated is another exemplary embodiment of the constructional building material in accordance with the present invention. This particular embodiment is similar to those discussed above in many respects. For instance, the building material 410 comprises first and second base sections 414 and 416. However, the building material 410 further comprises a first vane 420 and a second vane 422 extending between the first and second base sections 414 and 416, wherein the first and second vanes 420 and 422 are configured so as to provide and define a volume of space 438 and a corresponding fluid flow path 456 through the building material 410 that facilitates the flow of fluid through the building material 410. The volume of space 438 and the fluid flow path 456 are defined at least in part by the surface 436 of the vane 420, the surface 440 of the vane 422, and intermediate surfaces of the first and second base sections 414 and 416, respectively (see intermediate surface 438 of the first base section 414). The combined cross-sectional area of vanes 420 and 422 is less than the cross-sectional area of one of the base sections 414 or 416.

The fluid flow path 456 defines a multi-directional fluid flow path, wherein fluid is caused to travel along a diverted path and in a direction other than along a straight line when passing from the front surface to the rear surface (or vice versa) of the building material 410. In this case, fluid may enter the building material 410 about the intersection of the upper and front surfaces 424 and 432, travel about the two opposing surfaces 436 and 440 of the first and second vanes 420 and 422, and exit the building material about the intersection of the lower and rear surfaces 426 and 434, respectively. Of course, fluid may flow in a direction opposite this as well.

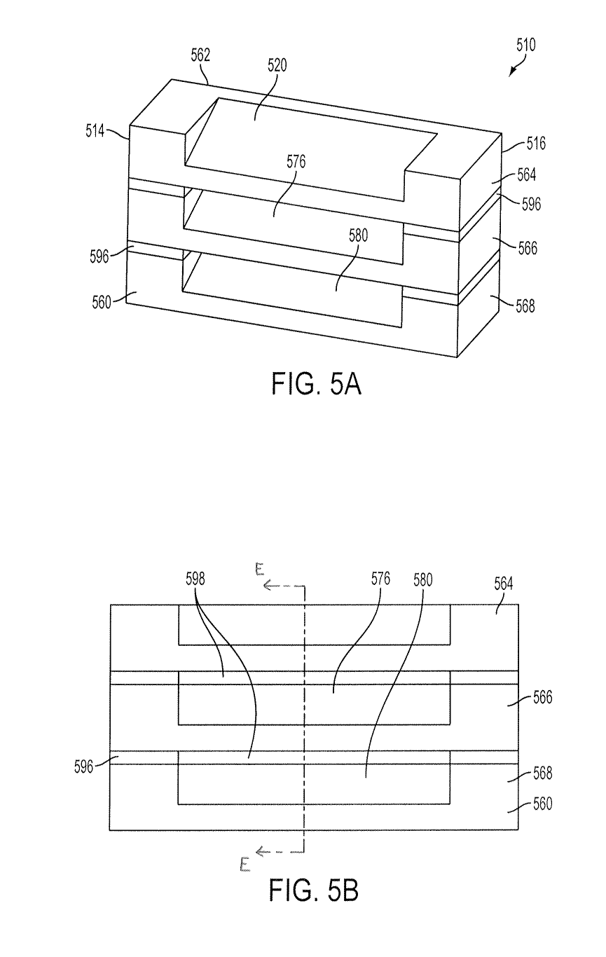

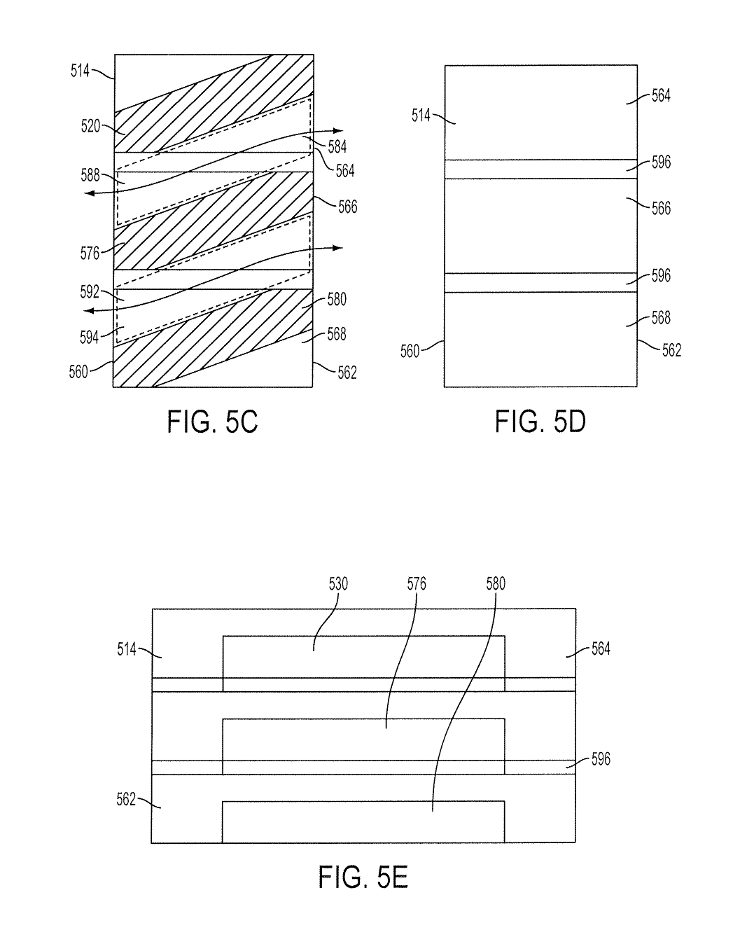

FIGS. 5A-5E illustrate an exemplary wall system (or at least a portion thereof) constructed or formed from a plurality of constructional building materials having a configuration in accordance with one exemplary embodiment of the present invention. Specifically, these figures illustrate that the wall system 510 may comprise a plurality of construction building materials 564, 566, and 568 as described above and shown in FIGS. 1A-1C. Although three of such building materials are shown stacked upon one another, this is not limiting in any way as any number of stacked building materials may be used.

The constructional building materials 564, 566 and 568 are essentially stacked relative to one another along a vertical axis, and positioned in proximity with one another, these being separated and secured together by a binding material, such as a mortar layer 596. The respective base sections of the several building materials function as the building blocks to facilitate stacking of the building materials in a vertical orientation, such as to form at least part of a wall system. As shown, the first building material 564 comprises first and second base sections 514 and 516, and a vane 520. Second and third building materials 566 and 568 are configured with similar base section and vane elements. The base sections of each of the building materials further comprise upper and lower surfaces, front and rear surfaces and end surfaces. To secure the building materials in place, a binding material or mortar may be placed between adjacent building materials about the surfaces of the base sections. The base sections of the adjacent building materials may be brought into position and properly aligned relative to one another.

By positioning two or more of the exemplary building materials of the present invention shown here in a stacked relationship, the respective vanes of the building materials are also positioned so as to define, at least in part, one or more common volumes of space. In the wall system 510, the vane 520 of the first building material 564 and the vane 576 of the second building material 566 are positioned so as to form and define a common volume of space 584, and a corresponding fluid flow path 588 between them. Likewise, the vane 576 of the second building material 566 and the vane 580 of the third building material 568 are positioned so as to form and define a common volume of space 592, and a corresponding fluid flow path 594 between them.

Together, the fluid flow paths 588 and 594 facilitate air flow through the wall system 510 from one side to the other as indicated by the arrows. Specifically, the wall system 510 comprises opposing sides, for example, a front side 560 and a rear side 562. When fluid, such as air, travels towards the wall system 510, rather than being impeded causing a buildup of pressure and increased wind loading, such as would occur with a traditional solid brick wall, the air passes through the wall system 510 via the formed fluid flow paths 588 and 594. When the pressure from wind loading is great, either a more robust wall may be required to withstand the resulting forces, or the wall may be configured as taught herein to facilitate passage of air through the wall. A thicker wall may not be ideal when constructing a wall system that is intended to be robust, but also efficient, inexpensive, aesthetic, or a combination of these. Here, the fluid flow paths 588 and 594 function to reduce the forces or loading acting on the wall system 510 caused by the movement of air (e.g., from the wind, high speed fans, etc.) by providing a way for the fluid to pass completely through the wall system at various locations. As such, the wall system 510 of the present invention may be designed in accordance with specifications that are less rigorous than would otherwise be required of a prior related wall for the same application. For example, for a given application, a wall system constructed from building materials formed after the manner described herein, would be subject to less wind loading as compared to a solid wall, the degree of the reduction of loading depending upon the number and configuration of the fluid flow paths formed therein. Essentially, for comparable walls of similar dimensions and construction, wherein one wall is solid and the other is formed after the manner taught herein, the present invention wall system will be stronger as it is able to reduce the forces acting upon it from a given fluid flow.

In addition, although it may be possible to construct a wall having sufficient durability for a given application, wherein the wall also functions to provide air flow through the wall, this is typically done using multiple layers (in terms of the depth or thickness of the wall) of stacked conventional building materials or bricks. Air flow through such a wall structure is provided by strategically positioning the bricks so as to create or form voids or spaces throughout the layers that define a fluid flow channel that facilitates air flow through the wall structure. Although visual obstruction may be up to total depending upon the particular configuration, a wall constructed in this manner requires multiple layers, increased design consideration, etc., thus greatly increasing labor and expense.

It will also be appreciate that the wall system 510 can be constructed in a variety of ways. For example, if each constructional building material comprised a masonry type brick, then a binding material, such as mortar, may be used to secure the constructional building materials together. On the other hand, if each constructional building material comprised a synthetic or plastic brick, then a binding material, such as an adhesive, could be used to secure the constructional building materials together. It will be further appreciated that there can be other ways in with the constructional building materials can be secured together to construct a wall system.

In regards to the capacity of the wall system of the present invention to provide visual obstruction while simultaneously providing airflow through the wall, the degree or level of obstruction can depend on several factors. There are situations and applications in which complete visual obstruction through the wall structure may be required and/or desired. On the other hand, something less than total (i.e., partial) visual obstruction through the wall structure may be sufficient or even desired. The level of visual obstruction may be a factor of the type of building material used (i.e., the particular configuration of the base section(s) and/or vane(s)), the construction of the wall, the line of sight available to observers, and in some instances the thickness of the binding material. Other factors not identified here may also come into play. It is contemplated that a wall system can be constructed that obstructs an observer's vision from any angle. For example, when constructing a wall system to surround and conceal an object, such as an air conditioner compressor unit, the wall system can be constructed in accordance with the wall system 510 as illustrated in FIGS. 5A-5E so as to provide partial visual obstruction through the wall system. Due to the given inclined orientation of the vanes, the wall system 510 can block, or at least highly obstruct, vision from an observer looking downward at a certain angle through the wall system 510. However, a line of sight along an axis orthogonal or substantially orthogonal to the vertical surface of the wall will not be obstructed. As shown, the binding material 596 causes adjacent building materials to be spaced apart a distance so as to create a gap 598 between the upper and lower surfaces of the adjacent building materials. This gap, which is particularly located about the adjacent vanes (the mortar being present only between adjacent base sections), allows a direct line of sight through the wall structure along an axis orthogonal to the vertical surface of the wall, and within a certain range of inclines both above and below this axis. Of course, a line of sight through the wall 510 will also exist along an axis (and a range of inclines above and below this axis) parallel or substantially parallel to the adjacent vanes, or rather the surfaces of the vanes.

In some cases, it may desirable to allow for line of sight vision through a wall system, particularly where the lines of sight may be specifically and strategically controlled by the configuration of the building material used, and the way in which a wall is constructed using these. For instance, if there is a line of sight that can be observed through a wall system, then light can also pass through that same line of sight. One application where this may be advantageous is a garden setting or for a back yard patio. A wall system could be constructed that permits sunlight to penetrate through the wall system only within a certain range of positions of the sun. The wall system may be constructed to block sunlight that shines below a 45° angle, thus allowing sunlight to shine through the wall system during the day, and to block sunlight when the sun drops closer to the horizon. Likewise, a similarly constructed wall system can control the amount and timing of sunlight that a garden receives, thus enhancing conditions for growth.

As discussed, the wall system 510 comprises a layer of binding material or mortar between adjacent building materials that creates a space or gap allowing direct line of sight vision through the wall system. However, contemplated herein are other exemplary wall systems formed from other exemplary building materials that provide up to complete or total visual obstruction through the wall system, while still facilitating the passage of fluid through the wall system, whether or not a binding material layer is present.

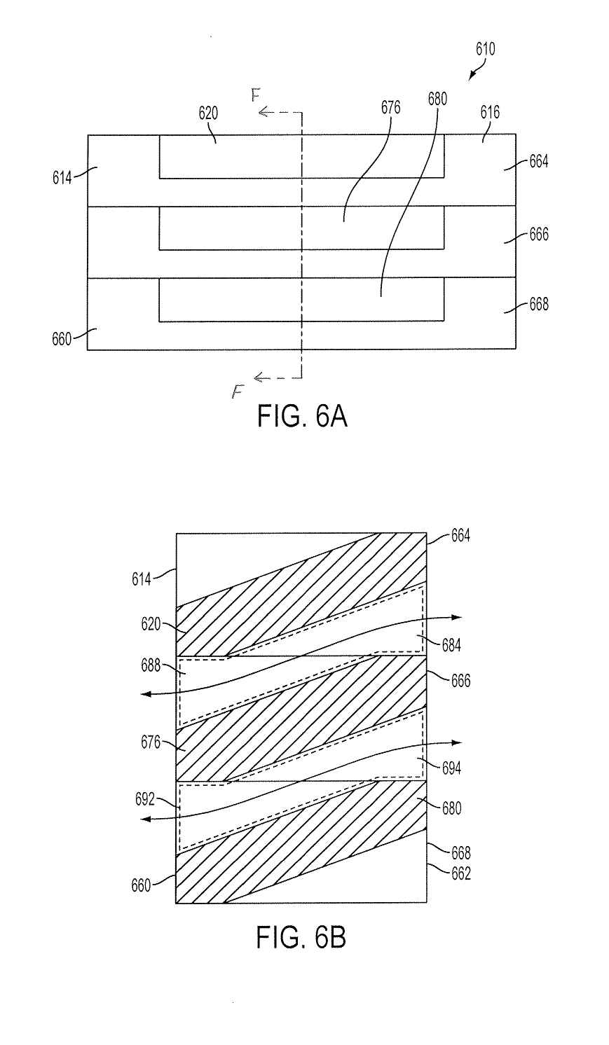

With reference to FIGS. 6A-6B, illustrated is an exemplary wall system 610 formed in accordance with the present invention, wherein the wall system 610 provides total visual obstruction at or above a horizontal line of sight. The wall system 610 is comprised of the same type or design of constructional building materials as described above and shown in FIGS. 1A-1C, and 5A-5E. However, unlike the wall system 510 shown in FIGS. 5A-5E, the wall system 610 shown here comprises no binding material between adjacent building materials. Because no binding material is employed in this wall system 610, adjacent bricks are stacked directly on top of one another, thus providing no gap between adjacent building materials. Therefore, line of sight through the wall system 610 is only provided along an axis parallel to the vanes of the building materials (and within a limited range of inclines above and below this axis), and particularly their surfaces, as oriented on an incline. Line of sight along an axis orthogonal or substantially orthogonal to the vertical surface of the wall system is totally obstructed as the upper and lower surfaces of the building materials are caused to be in contact with one another, even about the vanes.

The wall system 610 comprises a plurality of building materials, namely building materials 664, 666 and 668. As shown, the first building material 664 comprises first and second base sections 614 and 616, and a vane 620. Second and third building materials 666 and 668 are configured with similar base section and vane elements. The base sections of each of the building materials further comprise upper and lower surfaces, front and rear surfaces and end surfaces.

By positioning two or more of the exemplary building materials of the present invention shown here in a stacked relationship, the respective vanes of the building materials are also positioned so as to define, at least in part, one or more common volumes of space. In the wall system 610, the vane 620 of the first building material 664 and the vane 676 of the second building material 666 are positioned so as to form and define a common volume of space 684, and a corresponding fluid flow path 688 between them. Likewise, the vane 676 of the second building material 666 and the vane 680 of the third building material 668 are positioned so as to form and define a common volume of space 692, and a corresponding fluid flow path 694 between them. Together, the fluid flow paths 688 and 694 facilitate air flow through the wall system 610 from one side to the other as indicated by the arrows. The wall system 610 comprises opposing sides, for example, a front side 660 and a rear side 662.

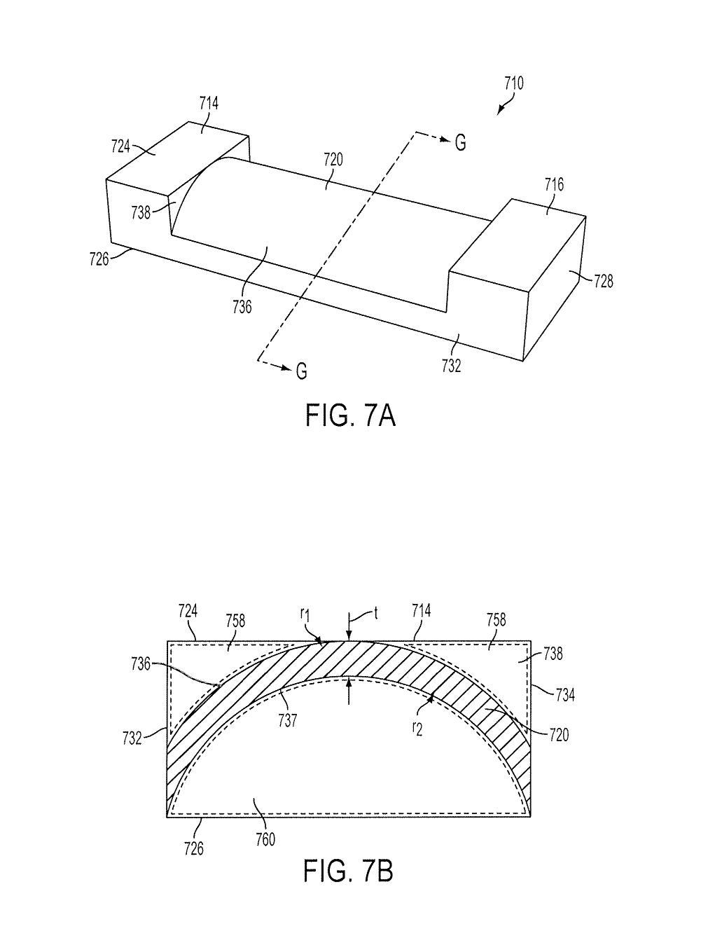

FIGS. 7A-7B illustrate a constructional building material in accordance with yet another exemplary embodiment. In many respects, the constructional building material 710 is similar to the different constructional building materials described above, comprising first and second base sections 714 and 716 defining, at least in part, an upper surface 724, a lower surface 726, a front surface 732, a rear surface 734, and end surfaces (see end surface 728). The base sections 714 and 716 comprise an elongated cube or block-like configuration with opposing surfaces being substantially parallel to one another, namely upper and lower surfaces 724 and 726, front and rear surfaces 732 and 734, and the end surfaces, respectively. An imaginary envelope boundary (not shown, but similar to those discussed above) surrounds or envelops the upper surface 724, lower surface 726, front surface 732 and rear surface 734 of the base section. The envelope boundary may also be considered to extend outward from the end most surfaces of the building material, along a longitudinal axis. The base section 714 further comprises or defines an intermediate surface 738, with base section 716 comprising a similar intermediate surface (not shown).

The constructional building material 710 further comprises a vane 720 having an upper vane surface 736, and a lower vane surface 737. The vane 720 extends between the first and second base sections 714 and 716, and defines, at least in part, a volume of space 758 about the upper vane surface 736 and a volume of space 760 about the lower vane surface 737. As in other embodiments, the volumes of space 758 and 760 are defined, at least in part, by the vane 720, wherein the cross-sectional area of the vane 720 within the envelope boundary being less than the cross-sectional area of one of the base sections 714 or 716. These volumes of space, together with the vane 720, help to define, at least in part, a fluid flow path that facilitates the passage of fluid through a wall or other structure formed at least in part from the building material 710.

In this particular embodiment, the vane 720 comprises a curved configuration (e.g., a semi-circular cross-sectional configuration) as viewed from the cross-section of FIG. 7B. The apex or uppermost point of the curved vane 720 is coplanar and tangential with the upper surface 724 of the building material 710 as defined by the base sections 714 and 716. However, the uppermost point of the curved vane 720 may be disposed at a lower or higher elevation. In other words, the curved vane 720 may be disposed between the base sections at various locations along a vertical axis. The vane 720 further comprises a thickness t that may vary with design. Moreover, the upper and lower surfaces of the vane may comprise a radius r₁ and r₂, respectively, that may vary with design. The curved vane is shown as being symmetrical, but this is not intended to be limiting in any way as the vane may also comprise an asymmetrical configuration, or some other configuration. As will be appreciated by those skilled in the art, a variety of functional and aesthetic vane configurations can be employed.

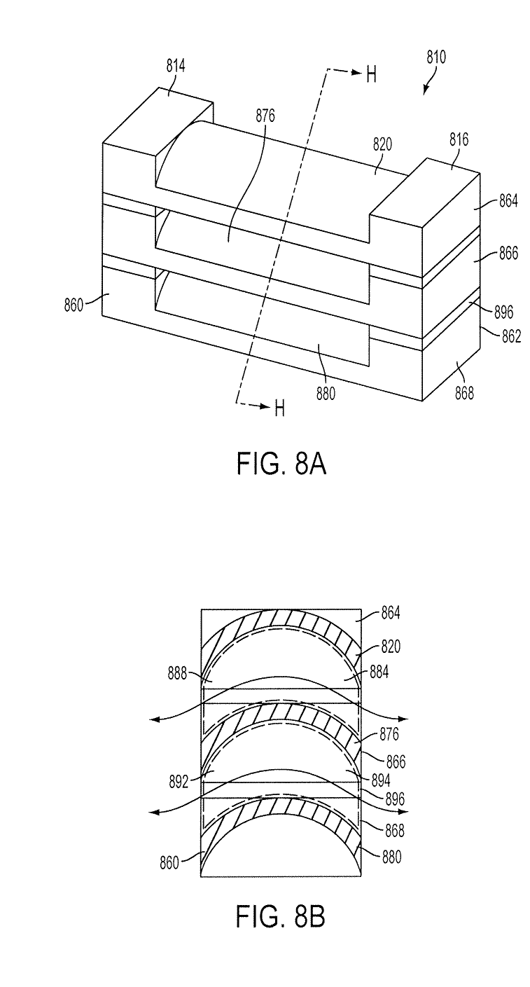

FIGS. 8A-8B illustrate an exemplary wall system (or at least a portion thereof) constructed or formed from a plurality constructional building materials having a configuration in accordance with that shown in FIGS. 7A-7B. Specifically, these figures illustrate that the wall system 810 may comprise a plurality of construction building materials 864, 866, and 868, as described above.

The constructional building materials 864, 866 and 868 are essentially stacked relative to one another along a vertical axis, and positioned in proximity with one another, these being separated and secured together by a binding material, such as a mortar layer 896. The respective base sections of the several building materials function as the building blocks to facilitate stacking of the building materials in a vertical orientation, such as to form at least part of the wall system 810. As shown, the first building material 864 comprises first and second base sections 814 and 816, and a vane 820. Second and third building materials 866 and 868 are configured with similar base section and vane elements. The base sections of each of the building materials further comprise upper and lower surfaces, front and rear surfaces and end surfaces.

By positioning two or more of the exemplary building materials of the present invention shown here in a stacked relationship, the respective vanes of the building materials are also positioned so as to define, at least in part, one or more common volumes of space. In the wall system 810, the vane 820 of the first building material 864 and the vane 876 of the second building material 866 are positioned so as to form and define a common volume of space 884, and a corresponding fluid flow path 888 between them. Likewise, the vane 876 of the second building material 866 and the vane 880 of the third building material 868 are positioned so as to form and define a common volume of space 892, and a corresponding fluid flow path 894 between them.

Together, the fluid flow paths 888 and 894 facilitate airflow through the wall system 810 from one side to the other as indicated by the arrows. Specifically, the wall system 810 comprises opposing sides, for example, a front side 860 and a rear side 862. When fluid, such as air, travels towards the wall system 810, rather than being impeded causing a buildup of pressure and increased wind loading, such as would occur with a traditional solid brick wall, the air passes through the wall system 810 via the formed fluid flow paths 888 and 894.

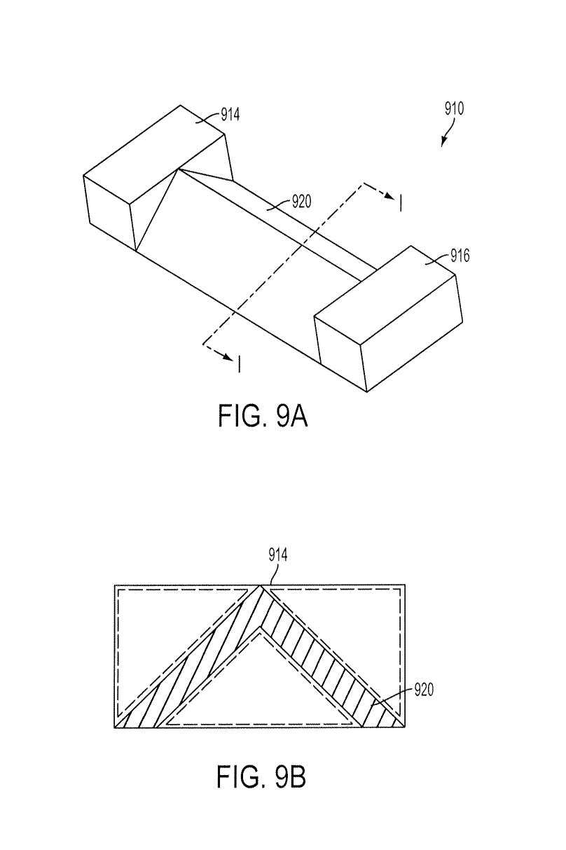

FIGS. 9A-9B illustrate a constructional building material in accordance with yet another exemplary embodiment. In many respects, the constructional building material 910 is similar to the various constructional building materials described above, and thus the similar elements and features are not discussed in detail. However, in this particular embodiment, the building material 910 comprises first and second base sections 914 and 916, and a vane 920 extending therebetween, wherein the vane 920 comprises an open triangular cross-sectional configuration. The cross-sectional area of the vane 920 is less than the cross-sectional area of one of the base sections 914 or 916 to define volumes of space above and below the surfaces of the vane 920 (see dotted lines).

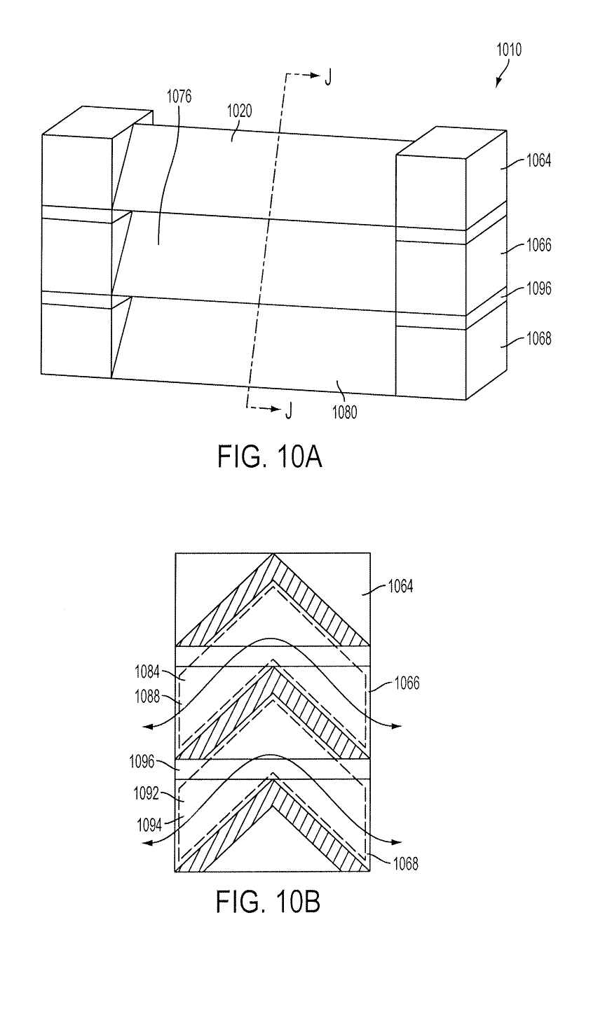

FIGS. 10A-10B illustrate an exemplary wall system (or at least a portion thereof) constructed or formed from a plurality constructional building materials having a configuration in accordance with that shown in FIGS. 9A-9B. Specifically, these figures illustrate that the wall system 1010 may comprise a plurality of construction building materials 1064, 1066, and 1068, as described above, that may be secured together by a binding material, such as a mortar layer 1096. Each of the first building materials may comprise first and second base sections, and a vane extending between these. By positioning two or more of the exemplary building materials of the present invention shown here in a stacked relationship, the respective vanes of the building materials are also positioned so as to define, at least in part, one or more common volumes of space, shown as volumes of space 1084 and 1092, and corresponding fluid flow channels 1088 and 1094, respectively, that facilitates air flow through the wall system 1010 from one side to the other as indicated by the arrows, and as described above.

As shown, the building materials of the wall system 1010 are secured together using a layer of binding material 1096. With the binding material present, the wall system 1010 will provide only partial visual obstruction due to a gap formed between adjacent building materials, thus creating a line of sight directly through the wall along an axis orthogonal to the vertical surface of the wall system. If no binding material is present, total visual obstruction can be obtained as the building materials will be stacked directly on top of one another, with the vanes further obstructing line of sight vision through the wall system as a result of the changing of direction of the surfaces making up the vanes. This concept is similar to the one discussed above in reference to FIGS. 5A-5E, and 6A-6B; only the vane is configured differently in this embodiment.

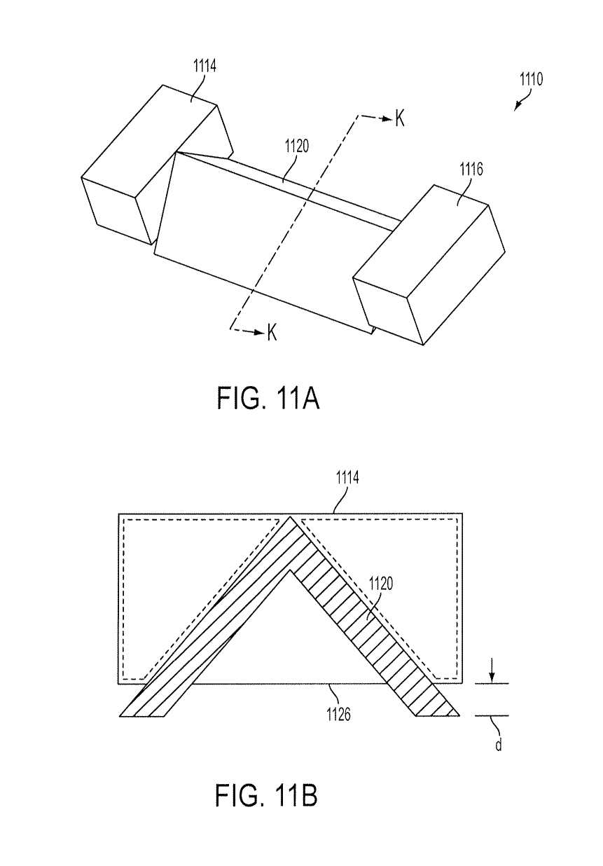

FIG. 11A-FIG. 11B illustrate a constructional building material in accordance with yet another exemplary embodiment. In many respects, the constructional building material 1110 is similar to the various constructional building materials described above, and thus the similar elements and features are not discussed in detail. However, in this particular embodiment, the building material 1110 comprises first and second base sections 1114 and 1116, and a vane 1120 extending therebetween, wherein the vane 1120 comprises an open triangular cross-sectional configuration. The vane 1120 is further configured to extend a distance d beyond the lower surface 1126 of the building material 1110 (and below the imaginary envelope boundary defined by the base sections) so as to further obstruct visibility through two like building materials 1110 stacked together with a binder material layer present between them. The various volumes of space are defined, at least in part, by the cross-sectional area of the portion of the vane 1120 within the imaginary envelope boundary being less than the cross-sectional area of one of the base sections 1114 or 1116.

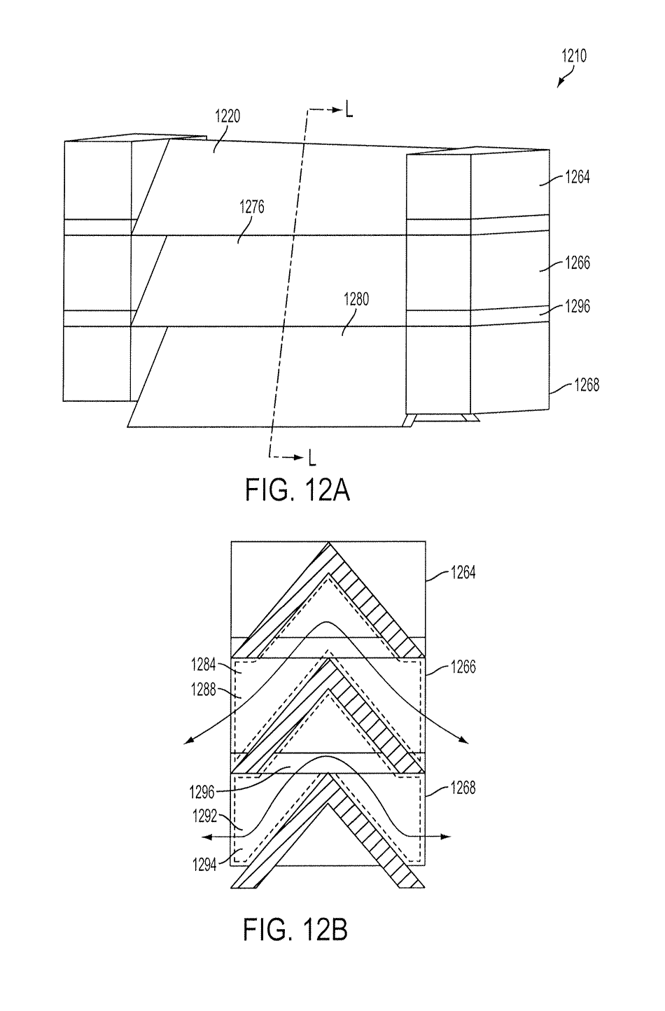

FIGS. 12A-12B illustrate an exemplary wall system (or at least a portion thereof) constructed or formed from a plurality constructional building materials having a configuration in accordance with that shown in FIGS. 11A-11B. Specifically, these figures illustrate that the wall system 1210 may comprise a plurality of construction building materials 1264, 1266, and 1268, as described above, that may be secured together by a binding material, such as a mortar layer 1296. Each of the first building materials may comprise first and second base sections, and a vane extending between these. By positioning two or more of the exemplary building materials of the present invention shown here in a stacked relationship, the respective vanes of the building materials are also positioned so as to define, at least in part, one or more common volumes of space, shown as volumes of space 1284 and 1292, and corresponding fluid flow channels 1288 and 1294, respectively, that facilitates air flow through the wall system 1210 from one side to the other as indicated by the arrows, and as described above.

In addition, the vanes are configured so as to provide complete visual obstruction through the wall system 1210. Essentially, the extended portion of the vane covers what may otherwise be a gap created between two adjacent building materials due to the presence of the binder material between building materials. In addition, as the vanes comprise a nonplanar surface and a change in direction (due to the vane surfaces comprising portions oriented along different axes or in different planes), no line of sight exists through the wall system from one side to the other.

The present invention further contemplates a wall system or other structure formed, at least in part, by two or more building materials having different structural configurations that are strategically designed to work or operate in concert to provide fluid flow and at least partial visual obstruction characteristics. The respective individual building materials involved in providing a multiple-part (e.g., two-part) design may be referred to as Part A, Part B, . . . , Part n. The multiple-part design provides similar advantages as the other building materials discussed herein, namely fluid flow or passage through a wall or other structure formed from the building materials.

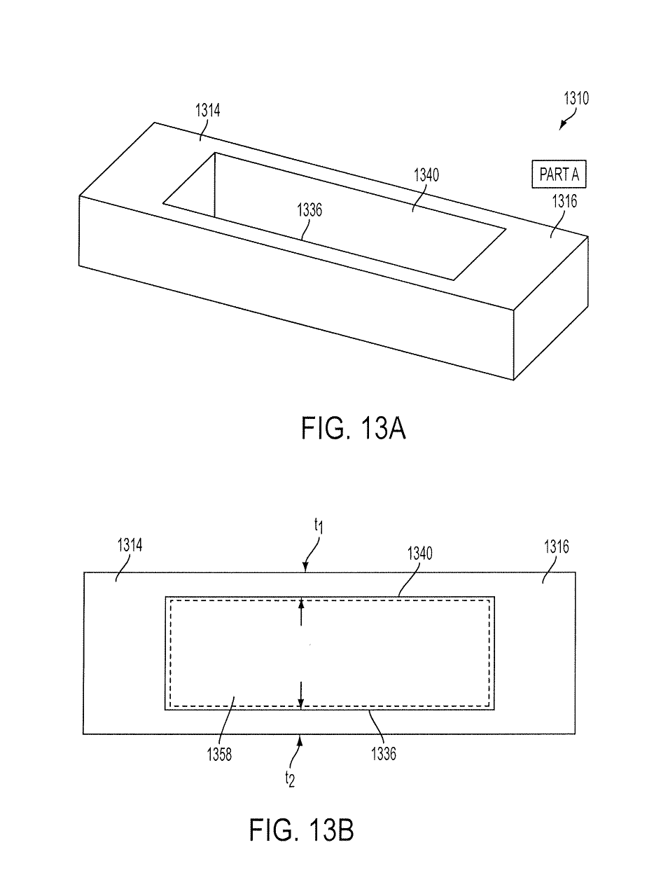

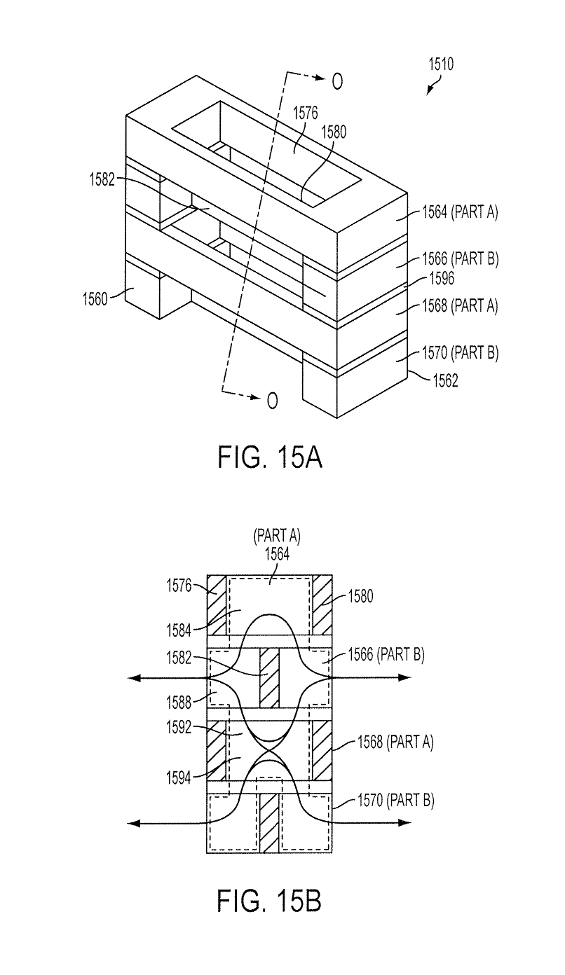

FIGS. 13A-13B illustrate a constructional building material in accordance with still another exemplary embodiment of the present invention, wherein the constructional building material 1310 comprises a first part, Part A, of a two-part design (see FIGS. 15A-15B). In this embodiment, the Part A building material 1310 comprises elements similar to those discussed above, namely first and second end sections 1314 and 1316. The building material 1310 further comprises first and second vanes 1336 and 1340 extending between the first and second end sections 1314 and 1316. The first and second vanes 1336 and 1340 are oriented vertically, and are parallel or substantially parallel to one another. The first and second vanes 1336 and 1340 are spaced apart so as to provide and define, at least in part, a volume of space 1358 therebetween. The first vane 1336 comprises a front surface that is coplanar with a front surface of the base sections 1314 and 1316. Likewise, the second vane section comprises a rear surface that is coplanar with a rear surface of the base sections 1314 and 1316. Of course, this is not to be limiting in any way, as the first and second vanes 1336 and 1340 may be located in a position offset from the various surfaces of the base sections 1314 and 1316 (e.g., located closer together). The first and second vanes 1336 and 1340 further comprise a uniform thickness t₁ and t₂, respectively, which may be, but is not limited to being, the same. In addition, as with any of the vanes of the present invention described herein, the first and second vanes 1336 and 1340 may comprise a non-uniform thickness. The combined cross-sectional area of vanes 1336 and 1340 is less than the cross-sectional area of one of the base sections 1314 or 1316 to define, at least in part, the volume of space 1358.

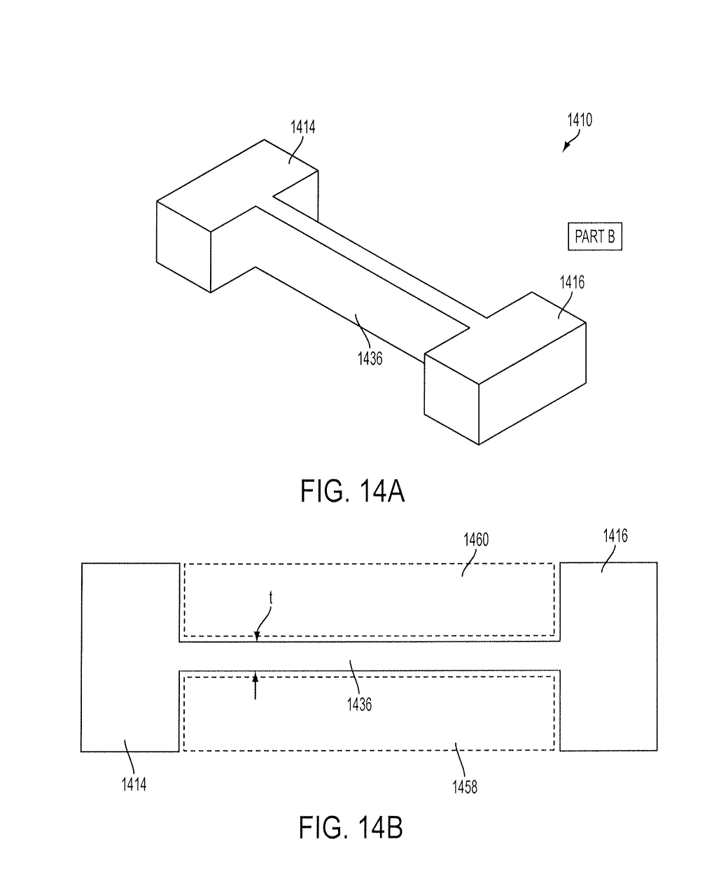

FIGS. 14A-14B illustrate a constructional building material in accordance with still another exemplary embodiment of the present invention, wherein the constructional building material 1410 comprises a second part, Part B, of a two-part design (see FIGS. 15A-15B). In this embodiment, the Part B building material 1410 comprises elements similar to those discussed above, namely first and second end sections 1414 and 1416. The building material 1410 further comprises a vane 1436 extending between the first and second end sections 1414 and 1416. The vane 1436 is oriented vertically, and comprises a thickness t. The vane 1436 is further located in a central position offset from the various surfaces of the base sections 1314 and 1316 so as to provide and define, at least in part, volumes of space 1458 and 1460. The vane 1436 of course may be located in a different position rather than being centrally located as will be appreciated by one skilled in the art. Again, the cross-sectional area of vane 1436 is less than the cross-sectional area of one of the base sections.

With reference to FIGS. 15A-15B, illustrated is a wall system formed in accordance with still another exemplary embodiment of the present invention. In this embodiment, the wall system 1510 is formed or constructed, at least in part, using the multi-part building material design discussed above. Specifically, the wall system 1510 comprises a two-part design, wherein a Part A building material is positioned adjacent a Part B building material about a vertical axis (e.g., stacked in the vertical direction). The Part A building materials shown herein (1564 and 1568) are similar to the building material 1310 discussed above and shown in FIGS. 13A-13B. The Part B building materials shown herein (1566 and 1570) are similar to the building material 1410 discussed above and shown in FIGS. 14A-14B.

Each of the constructional building materials 1564, 1566, 1568, and 1570 are configured with base section and vane elements similar to those discussed above, and are separated and secured together by a binding material, such as a mortar layer 1596. The respective vanes of the adjacently positioned building materials are positioned so as to define, at least in part, one or more common volumes of space. In the wall system 1510, the vanes 1576 and 1580 of the first Part A building material 1564 and the vane 1582 of the first Part B building material 1566 are positioned so as to form and define a common volume of space 1584, and a corresponding fluid flow channel or path 1588.

As the wall system 1510 comprises two alternating Part A and Part B building materials, the common volume of space 1584 may be caused to merge or join with another common volume of space, namely that formed or defined by the vanes of the second Part A building material and the vane of the second Part B building material, which are positioned so as to form and define a common volume of space 1592, and a corresponding fluid flow path 1594 between them. As can be seen, the configuration of the building materials allows the common volume of space 1584 and the common volume of space 1592 to be combined into a single common volume of space spanning the four building materials 1564, 1566, 1568 and 1570. As is shown by the arrows, additional fluid flow paths are defined through the wall system 1510 about the various vanes in the adjacent building materials. For instance, airflow entering one side (either of sides 1560 or 1562) of the wall system 1510 through or about the Part B building material 1566 may travel about a variety of fluid flow paths, such as 1) above and over the vane 1582 through the Part A building material 1564 and out the other side of the wall system 1510 through the Part B building material 1566, 2) below and under the vane 1582 through the Part A building material 1568 and out the other side of the wall system 1510 through the Part B building material 1566, 3) below and under the vane 1582 through the Part A building material 1568 and out the other side of the wall system 1510 through the Part B building material 1570, or 4) through the Part A building material 1568 and out the same side of the wall through the Part B building material 1570. Similar fluid flow paths may be available for airflow entering the wall system 1510 at other locations. Thus, although a two-part system, the fluid flow channels 1588 and 1594 facilitate air flow through the wall system 1510 from one side to the other as indicated by the arrows in a similar manner as discussed above.

Although the wall system 1510 is shown as being constructed using a binding material 1596, such as mortar, the way system 1510 could be constructed without such a binding material, wherein the individual Part A and Part B building materials may be placed directly in contact with one another. In this configuration, the fluid flow channels would still facilitate airflow through the wall system as air is able to enter into the wall system from one side, travel about similar fluid flow paths discussed above, and exit the opposing side of the wall system.

Moreover, as can be seen, multi-part building materials can be stacked in a sequential manner to form, at least in part, a wall system. In one example, such as that shown in FIGS. 15A-15B, the Part A building material may be alternated with the Part B building material as often as needed (e.g., Part A, Part B, Part A, Part B, and so on). In another example, the wall system may comprise more of one particular Part than the other. For example, a wall system may be constructed with Part A and Part B building materials, with these being arranged in a Part B, Part A, Part A, Part A, Part B order. Of course, other orders are possible and those discussed herein are not meant to be limiting in any way.

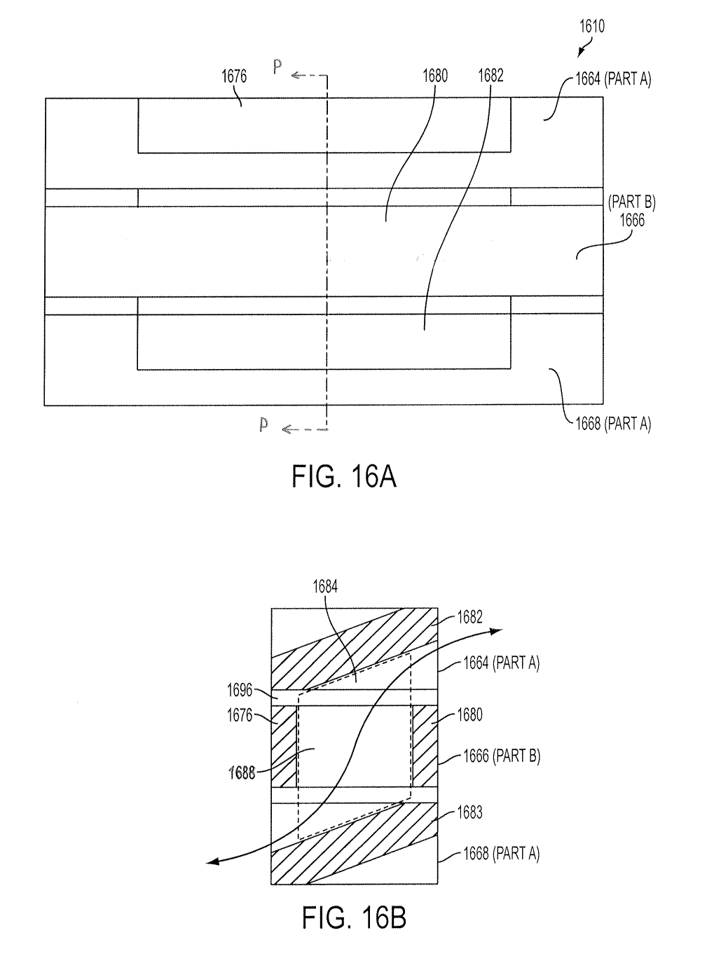

FIGS. 16A-16B illustrate a multi-part wall system formed in accordance with another exemplary embodiment of the present invention. In this embodiment, the wall system 1610 comprises a Part A building material 1664 having a similar configuration as the building material 10 described above and shown in FIGS. 1A-1C, and a Part B building material having a similar configuration as the building material 1310 described above and shown in FIGS. 13A-13B. The wall system 1610 is shown as comprising the Part A building material 1664 positioned adjacent and above the Part B building material 1666, which is positioned adjacent and above another Part A building material 1668, these being arranged in a stacked relationship having a binding material 1696 securing them together. The multi-part wall system is configured to provide fluid flow through the wall system upon having traveled about at least two rows of building materials, or at least two stacked building materials, and in some cases more than two. The vane configuration of a first building material is designed to permit fluid flow to enter the wall system at one location through the volume of space within the first building material. The vane configuration of a second building material, being different, is designed to direct the fluid, once within the wall system, along a fluid flow path within a fluid flow channel through the volume of space within the second building material, which is located in a different row (e.g., a building material located in an above or below position). The fluid may exit at a location on an opposing side of the wall that is at the same or a different elevation than the location it entered, depending upon the different configurations of the various vanes employed.

A common volume of space 1684 and an associated fluid flow channel 1688 are defined, at least in part, by the arrangement of the three individual building materials 1664, 1666, and 1668, as well as the respective vanes of each of these, namely vane 1682 of the Part A building material 1664, vanes 1676 and 1680 of the Part B building material 1666, and vane 1683 of the Part A building material 1668. As such, fluid flow through the wall system 1610 is facilitated as in other embodiments discussed herein. Although the wall system 1610 is shown as comprising a single Part B building material, a plurality of Part B building materials may be positioned between two Part A building materials to provide as long a fluid flow path along a vertical axis as needed or desired.

The above wall systems 1510 and 1610 are two examples of wall systems that can simultaneously facilitate airflow through, from one side to the other, a single deep layer of building materials (e.g., one building material thick), and that can also provide controlled fluid flow through a plurality of defined fluid channels and associated flow paths, including those about multiple rows of building materials (e.g., several building materials high where the fluid flow path is directed at least in part along a vertical axis). In addition, the above wall systems 1510 and 1610 illustrate how fluid flow can be directionally controlled to enter at one elevation on one side of the wall system, pass through the wall system, and exit the wall system at another higher or lower elevation. For example, in the case of an air conditioner unit, air can be efficiently drawn through the wall system near the base of the unit and pushed out through the wall system near the top of the unit. Thus, fluid can be specifically controlled by strategically constructing a wall system after the manner herein. One of skill in the art would appreciate the various configurations possible to control the direction of fluid flow using a wall system according to the present invention.

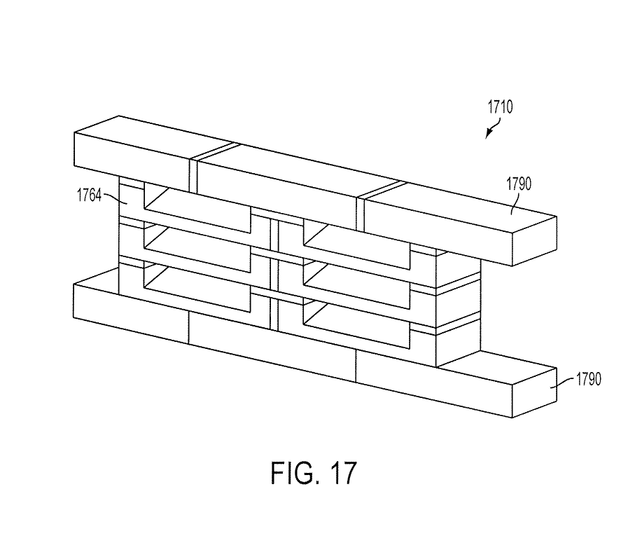

FIG. 17 illustrates a wall system formed in accordance with still another exemplary embodiment of the present invention. In this particular embodiment, the wall system 1710 comprises building materials formed after the manner discussed herein, namely those with base sections and vanes extending therebetween, which are combined with more traditional building materials, such substantially solid building materials or building materials having a uniform cross-section along a longitudinal axis (e.g., a standard, well known masonry brick). As shown, the wall system 1710 comprises three layers or rows high of present invention building materials 1764 positioned between a single layer or row of traditional building materials 1790 on each side, along a vertical axis. This demonstrates how a wall system may be formed or constructed after a more traditional manner, with select portions or sections of the wall system incorporating the building materials of the present invention, thus incorporating the benefits of fluid flow, up to total vision obstruction, and reduced wind loading to more traditional walls. In other words, incorporating building materials of the present invention to a traditional wall can be used to create airflow “windows” at strategic locations.

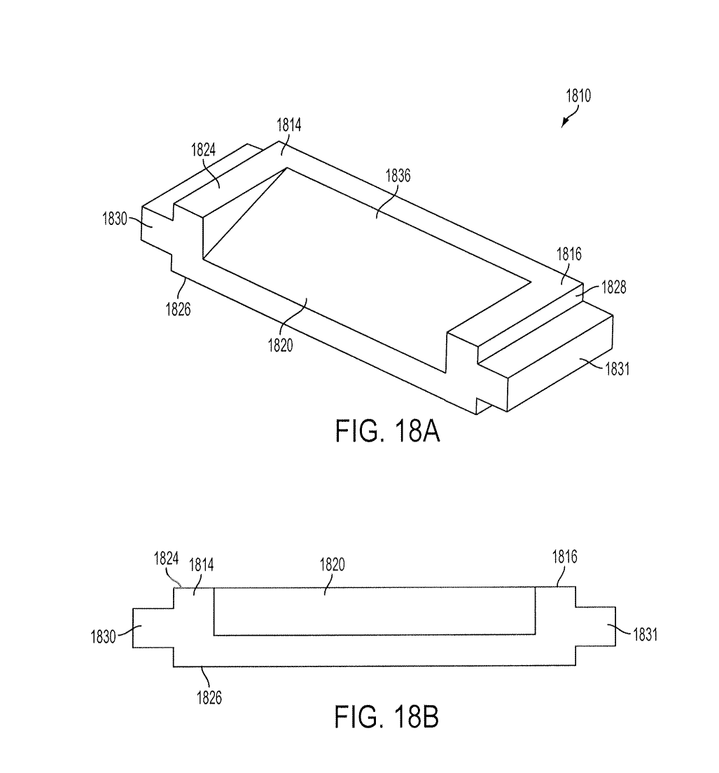

FIGS. 18A-18B illustrate a constructional building material in accordance with still another exemplary embodiment. In this embodiment, the building material 1810 comprises a similar configuration as the building material 10 described above and shown in FIGS. 1A-1C, with first and second base sections 1814 and 1816, and a vane 1820 extending between these defining a vane surface 1836. However, in this embodiment, the building material further comprises first and second mating components 1830 and 1831 extending outward along a longitudinal axis from the base sections 1814 and 1816, respectively. The mating components 1830 and 1831 each are shown as comprising a projection tab having a square cross-sectional configuration, but this is not limiting in any way. The mating components are designed to allow the building material to mate with or otherwise engage and operate with similar or corresponding mating components of one or more laterally positioned adjacent building materials, as will be described below. In this particular embodiment, the mating components 1830 and 1831 comprise a height that is less than the height of the base sections, and surfaces parallel to, but out of plane with the surfaces (e.g., surfaces 1824 and 1826) of the base sections, respectively.

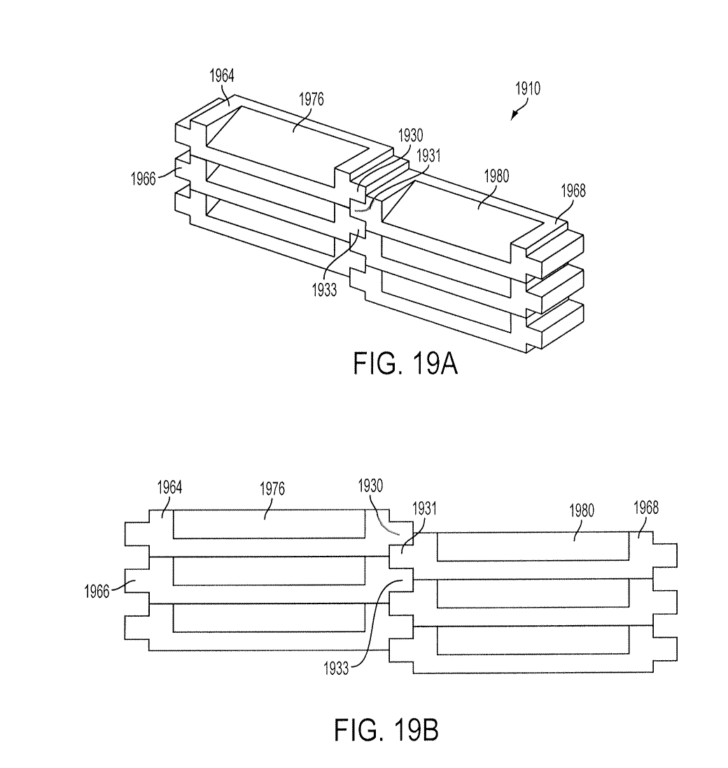

FIGS. 19A-19B illustrate a wall system formed in accordance with another exemplary embodiment, and particularly with constructional building materials similar to those described above and shown in FIGS. 18A-18B. The wall system 1910 comprises a plurality of constructional building materials vertically staggered that functions to provide for a stronger wall, and one that is more aesthetically varied. The building materials are staggered by mating or engaging the mating components of adjoining building materials. For example, as shown, building material 1964 comprises a mating component 1930 that engages with a mating component 1931 of building material 1968 in a staggered relationship, which mating component 1931 engages also with a mating component 1933 of building material 1966, also in a staggered relationship. This staggering pattern may be continued for as many building materials as needed or desired. By staggering the building materials, the associated vanes are also staggered (see staggered vanes 1976 and 1980), thus contributing to the varied look of the wall system.

The particular building materials shown in the wall system 1910 are not meant to be limiting in any way. Indeed, those skilled in the art will recognize that the building material may comprise different vane configurations, different base section configurations, different mating component configurations, etc. as needed or desired.

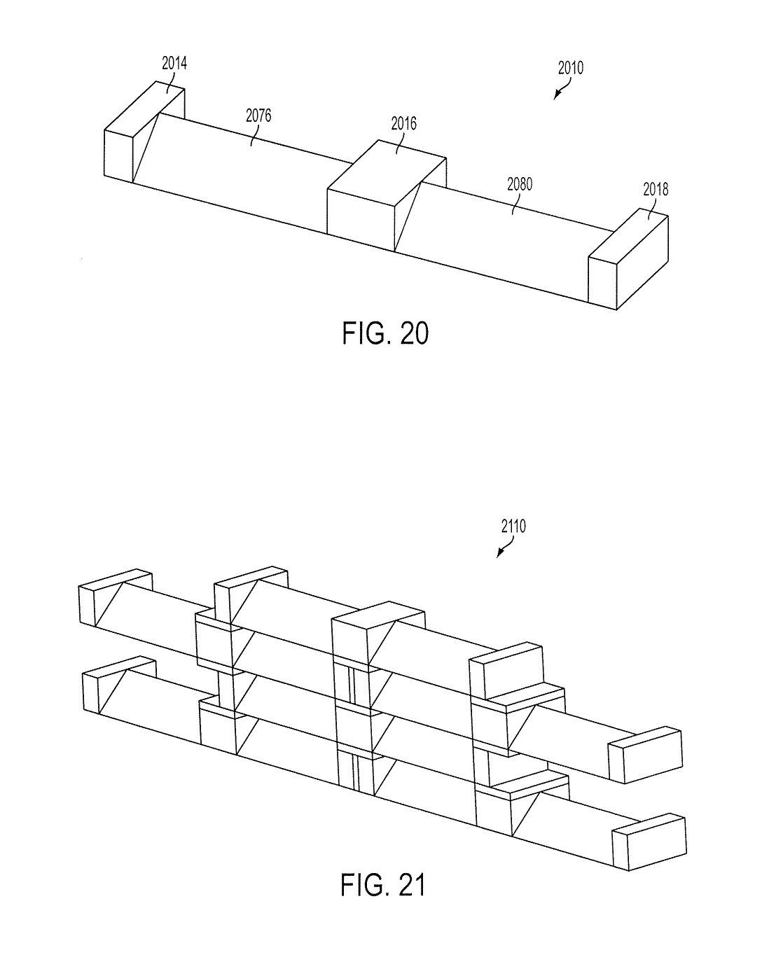

FIG. 20 illustrates a constructional building material in accordance with still another exemplary embodiment of the present invention. In this embodiment, the constructional building material 2010 comprises three base sections, namely base sections 2014, 2016 and 2018. Extending between the first and second base sections 2014 and 2016 is a first vane 2076. Likewise, extending between the second and third base sections 2016 and 2018 is a second vane 2080. The vane configuration is similar to that described above and shown in FIGS. 9A-9B. However, this is not intended to be limiting in any way as the vane configuration of the double wide vane building material 2010 can be any vane configuration as described herein, as well as others apparent to those skilled in the art. As such, the building material 2010 functions in many respects similar to those described above, only the building material 2010 comprises a double wide vane configuration. Another way to describe the constructional building material 2010 is that it comprises two end base sections, and a middle or intermediate base section, with the vane extending from this middle or intermediate base section in opposing directions towards the two end base sections. Providing a double wide vane configuration allows for horizontal staggering of rows of building materials that can be used to make the resulting wall system stronger, as well as more aesthetically varying.

The first and second end base sections 2014 and 2018 are shown as being smaller in size or comprising a reduced area (smaller in width as viewed from a front view) than the middle base section 2016, which facilitates horizontal staggering of rows as will be shown below. A wall system comprised of a plurality of constructional building materials formed after the manner of the building material 2010 is illustrated in FIG. 21. This wall system 2110 comprises four rows of building materials. As can be seen, each of the various end base sections of the several building materials can be positioned adjacent one another along a horizontal axis, with the combined width of these being the same as the width of the middle base section of an adjacent building material in a higher or lower row. In this manner, the wall system 2110 can be constructed with the several building materials in one row being positioned in a staggered relationship with the several building materials in an adjacent row, thus increasing the strength of the wall system much in the same way traditional walls are strengthened that are built in a staggered configuration. The respective vane sections are positioned as taught above, such that a combined volume of space and a corresponding fluid flow channel are formed that facilitates fluid flow through the wall system 2110 as taught herein.

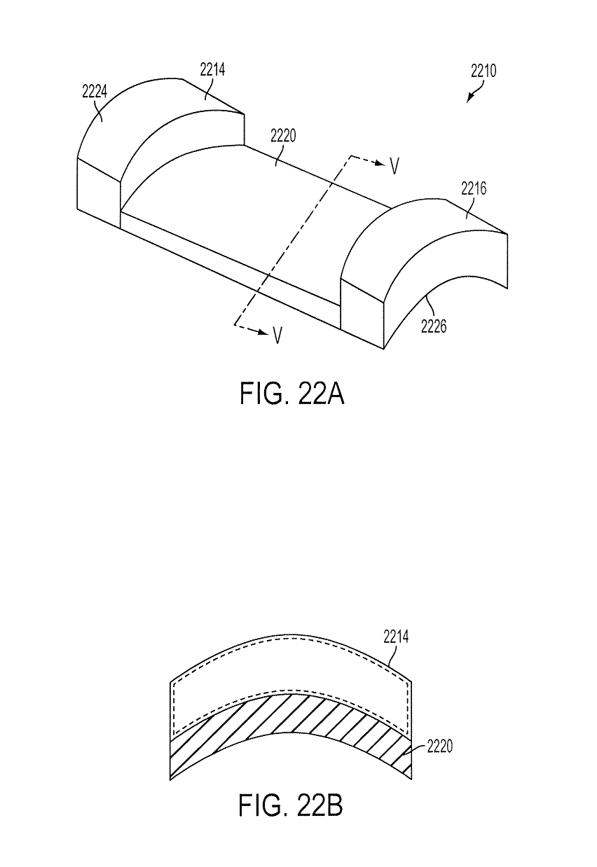

FIGS. 22A and 22B illustrate a constructional building material in accordance with yet another exemplary embodiment. In many respects, the constructional building material 2210 is similar to the various constructional building materials described herein, and thus the similar elements and features are not discussed in detail here. However, in this particular embodiment, the building material 2210 comprises first and second base sections 2214 and 2216, each base section having an upper surface 2224 and a lower surface 2226. The base sections 2214 and 2216 are each shown as comprising a non-planar or curved configuration, with the upper and lower surfaces 2224 and 2226 being curved. As will be appreciated by those skilled in the art, and although not discussed here or shown in drawings, the base sections 2214 and 2216, and the upper and lower surfaces 2224 and 2226, may comprise a variety of non-planar configurations.

In this particular embodiment, the upper and lower surfaces 2224 and 2226 are substantially symmetrical to each other. Symmetrical surfaces may assist in facilitating similar constructional building materials mating or nesting together when combined to form a wall system. Alternatively, the upper and lower surfaces 2224 and 2226 of the building material 2221 do not need to be symmetrical or substantially parallel to each other. For example, a constructional building material having base sections comprising a flat lower surface and a curved upper surface may be used to construct all or part of a wall system.

This particular embodiment further illustrates that the first and second base sections 2214 and 2216 need not comprise a block-like (e.g., elongated cube, cuboid) configuration (e.g., those having a uniform cross-section along a longitudinal axis), or be constrained to dimensions of traditional building materials. For example, a base section may be triangular, hexagonal or curved in its cross-sectional shape, depending on the desired look of the wall structure to be constructed. As stated above, the cross-sectional area of the base section used to relate to the portion of the vane in defining the volume of space, at least in part, will likely be the largest cross-sectional area of the base section, taken orthogonal to the longitudinal axis.

FIGS. 22A and 22B also illustrate a vane 2220 extending between the first and second base sections 2214 and 2216, wherein the vane 2220 comprises a curved configuration (e.g., a semi-circular cross-sectional configuration) as viewed from the cross-section of FIG. 22B. The upper and lower surfaces 2224 and 2226 of the vane 2220 may configured to be parallel (as shown in this embodiment) or non-parallel (as shown elsewhere herein).

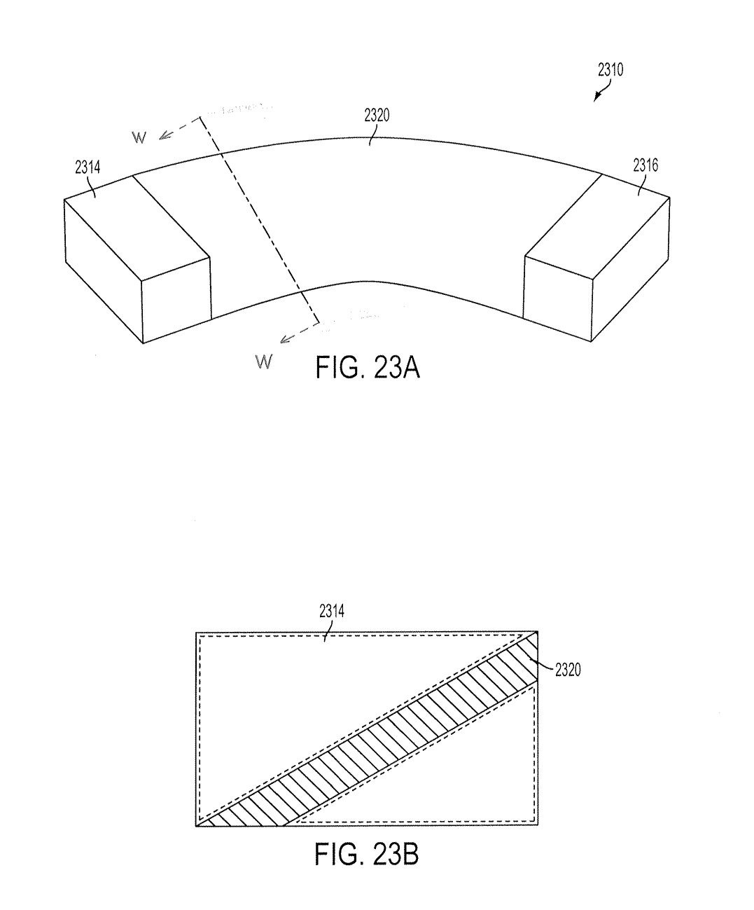

FIGS. 23A and 23B illustrate a constructional building material in accordance with yet another exemplary embodiment. In many respects, the constructional building material 2310 is similar to the various constructional building materials described above, and thus the similar elements and features are not discussed in detail here. The building material 2310 comprises first and second base sections 2314 and 2316, and a vane 2320 extending therebetween. However, unlike other embodiments described herein, the first and second base sections 2314 and 2316 are not substantially parallel to each other, but rather lie along a nonlinear (e.g., curved) longitudinal axis, wherein the constructional building material comprises a nonlinear configuration along its longitudinal axis. This may be preferred when building a structure that is non-linear, such as a wall with rounded corners. Moreover, the building material 2310 comprises a vane 2320 that extends between the base sections 2314 and 2316, and that is also curved, along the curved longitudinal axis. Although shown as comprising a configuration similar to that shown in FIGS. 1A-1C, the vane 2320 may comprise a variety of different configurations (such as those taught herein) that extend between the first and base sections 2314 and 2316. Likewise, the base sections 2314 and 2316 may comprise different configurations as taught herein. Thus, a wall structure can be built in a plurality of configurations by altering the configuration of the vane 2320 and the base sections 2314 and 2316.

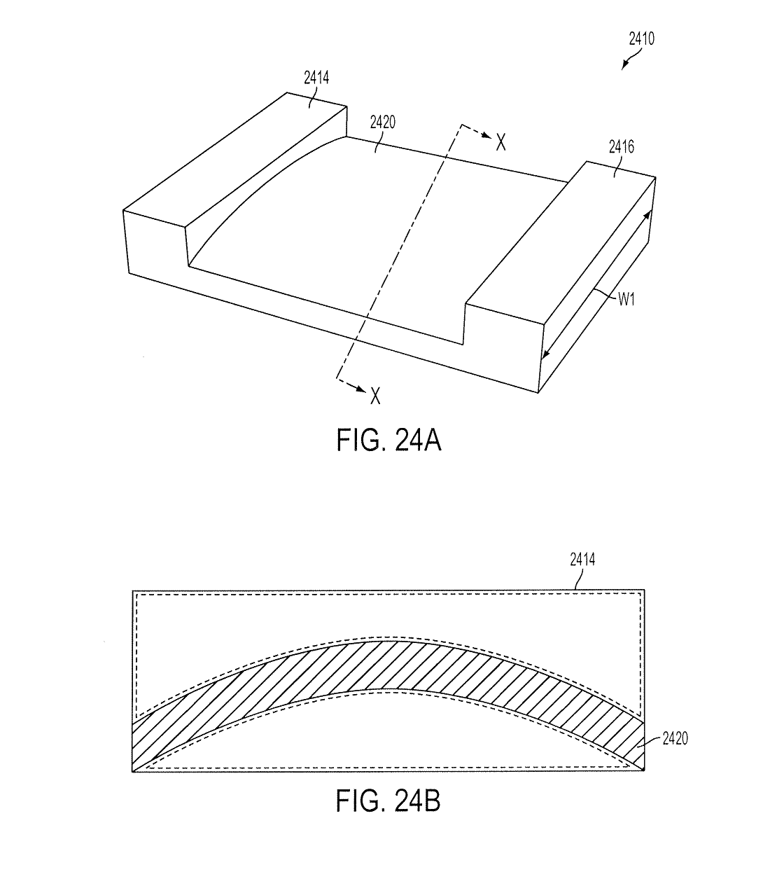

FIGS. 24A and 24B illustrate a constructional building material in accordance with yet another exemplary embodiment. In many respects, the constructional building material 2410 is similar to the various constructional building materials described above, and thus the similar elements and features are not discussed in detail here. However, in this particular embodiment, the building material 2410 comprises first and second base sections 2414 and 2416, and a vane 2420 extending therebetween, wherein the building material is configured similarly to that discussed above and shown in FIGS. 7A and 7B. As discussed previously, the base sections 2414 and 2416 need not be constrained in their dimensions to that of traditional constructional building materials. In this embodiment, and unlike the embodiment of FIGS. 7A and 7B, the width W1 of each of the base sections is elongated such that it is at least twice the dimension as the height of the base sections, thus providing multiple advantages, as will be discussed below. As a result, the surfaces of the vane 2420 are shown as being configured to comprise a greater radius, respectively, than those of the vane discussed above and shown in FIGS. 7A and 7B.

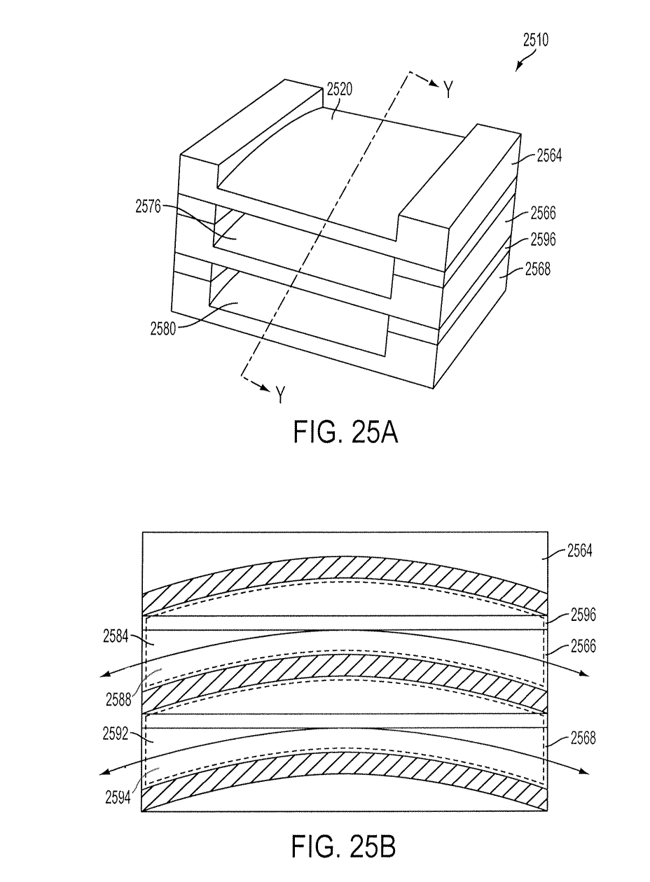

FIGS. 25A and 25B illustrate an exemplary wall system (or at least a portion thereof) constructed or formed from a plurality constructional building materials having a configuration in accordance with that shown in FIGS. 24A and 24B. Specifically, these figures illustrate that the wall system 2510 may comprise a plurality of construction building materials 2564, 2566, and 2568, as described above, which may be secured together by a binding material, such as a mortar layer 2596. By positioning two or more of the exemplary building materials of the present invention shown here in a stacked relationship, the respective vanes 2520, 2576, and 2580 of the building materials are also positioned so as to define, at least in part, one or more common volumes of space, shown as volumes of space 2584 and 2592, and corresponding fluid flow channels 2588 and 2594, respectively, that facilitates air flow through the wall system 2510 from one side to the other as indicated by the arrows, and as described above.

In this wall system embodiment, each base section comprises an elongated width in accordance with the building material shown in FIGS. 24A and 24B. Elongating the width of the base sections may provide many advantages over base sections having less elongated widths. For example, a base section having an elongated width increases the upper and lower surface areas on the base section, which allows additional binding material, such as mortar, to be applied and disposed between stacked building materials, thus creating a stronger wall structure. Additionally, increasing the surface area on the base sections allows for a larger support foundation for other constructional building materials to rest on, also contributing to stronger structures, as well as wall structures that may comprise greater heights.

Elongating the width of the base section also allows the vane to be elongated as shown in this embodiment. An elongated vane allows the fluid flow channels, discussed above, to be flatter in nature. This reduces resistance to fluids passing through the fluid flow channels. Therefore, elongated vanes allow for reduced wind loads as applied to the wall system relative to the wind loads of traditional screen walls or even other exemplary wall systems described herein. Additionally, building materials having an elongated width offers the advantage of increased degrees of visual obstruction by reducing the angle of observance made available through a wall system.

The foregoing detailed description describes the invention with reference to specific exemplary embodiments. However, it will be appreciated that various modifications and changes can be made without departing from the scope of the present invention as set forth in the appended claims. The detailed description and accompanying drawings are to be regarded as merely illustrative, rather than as restrictive, and all such modifications or changes, if any, are intended to fall within the scope of the present invention as described and set forth herein. While the forgoing examples are illustrative of the principles of the present invention in one or more particular applications, it will be apparent to those of ordinary skill in the art that numerous modifications in form, usage and details of implementation can be made without the exercise of inventive faculty, and without departing from the principles and concepts of the invention.

More specifically, while illustrative exemplary embodiments of the invention have been described herein, the present invention is not limited to these embodiments, but includes any and all embodiments having modifications, omissions, combinations (e.g., of aspects across various embodiments), adaptations and/or alterations as would be appreciated by those skilled in the art based on the foregoing detailed description. The limitations in the claims are to be interpreted broadly based on the language employed in the claims and not limited to examples described in the foregoing detailed description or during the prosecution of the application, which examples are to be construed as non-exclusive. Any steps recited in any method or process claims may be executed in any order and are not limited to the order presented in the claims. Accordingly, the scope of the invention should be determined solely by the appended claims and their legal equivalents, rather than by the descriptions and examples given above.

1. A method for forming a constructional building material, comprising:
forming a first base section having a perimeter surface defining an envelope boundary extending along a longitudinal axis;
forming at least one vane extending outward from said first base section along said longitudinal axis, said vane comprising a first vane surface; and
configuring said vane such that a cross-sectional area of a portion of said vane within said envelope boundary is less than a cross-sectional area of said base section, wherein a volume of space is defined about said first vane surface and within said envelope boundary.

2. The method of claim 1, further comprising forming said constructional building material from a masonry-type material, and configuring said constructional building material as a type of masonry brick.

3. The method of claim 1, further comprising forming said constructional building material from a plastic material.

4. The method of claim 1, wherein said forming at least one vane further comprises causing a portion of said vane to extend beyond said envelope boundary.

5. The method of claim 1, wherein said forming at least one vane further comprises causing said vane to be entirely within said envelope boundary.

6. The method of claim 1, further comprising forming a second base section, wherein said vane extends between said first base section and said second base section.

7. The method of claim 1, wherein said forming a first base section further comprises causing first and second surfaces of said base section to be substantially parallel to one another.

8. The method of claim 1, wherein said forming a first base section further comprises causing first and second surfaces to be non-parallel to one another.

9. The method of claim 1, further comprising forming a second vane extending outward from said first base section, wherein said second vane operates to define, at least in part, a volume of space about a surface of said second vane.

10. The method of claim 9, wherein said forming a second vane further comprises causing said second vane to be parallel to said first vane.

11. The method of claim 9, wherein said forming a second vane further comprises causing said second vane to be non-parallel to said first vane.

12. The method of claim 9, wherein said second vane operates with said first vane to define, at least in part, a common volume of space and a fluid flow channel that facilitates fluid flow through said building constructional material along a fluid flow path.

13. The method of claim 1, wherein said vane comprises a cross-sectional configuration selected from the group consisting of rectangular, substantially rectangular, v-shaped, semi-circular, and any combination of these.

14. The method of claim 1, wherein said forming a first base section further comprises forming a mating component on said first base section that operates to engage a mating component of an adjacent constructional building material, said mating components facilitating vertical staggering of said constructional building materials.

15. The method of claim 1, further comprising:
forming said first base section as a first end base section;
forming a middle base section, said first vane extending between said first end base section and said middle base section;
forming a second end base section; and
forming a second vane that extends between said middle base section and said second end base section.

16. The method of claim 1, wherein said forming a first base section further comprises causing at least one surface of said first base section to comprise a non-planar or curved configuration.

17. The method of claim 1, wherein said first base section and said vane are disposed along a longitudinal axis having a nonlinear configuration, said constructional building material having a nonlinear longitudinal configuration.

18. The method of claim 1, wherein said forming a first base section further comprises causing an elongated width of said first base section to comprise a dimension at least twice that of a height of said base section.

19. A method for forming at least a portion of a wall system having opposing sides, said method comprising:
obtaining a first constructional building material having at least one base section and at least one vane extending outward from said base section;
obtaining a second constructional building material having at least one base section and at least one vane extending outward from said base section, said base sections of said first and second constructional building materials each having a perimeter surface defining an envelope boundary extending along a longitudinal axis; and
forming a common volume of space defined, at least in part, by said vane of said first constructional building material and said vane of said second constructional building material, wherein said common volume of space defines, at least in part, a fluid flow channel that facilitates fluid flow through said wall system from one of said opposing sides of said wall system to the other of said opposing sides of said wall system along a fluid flow path.

20. The method of claim 19, further comprising orienting said vanes of said first and second constructional building materials to be substantially parallel to one another.

21. The method of claim 19, wherein said fluid flow channel provides directional fluid flow control depending upon a respective orientation of said vanes.

22. The method of claim 19, further comprising disposing said first and second constructional building materials in a different elevation adjacent one another in a vertically staggered configuration, wherein at least one of said first and second constructional building materials comprises a mating component that facilitates said vertically staggered configuration about at least one of said respective base sections, said mating component being configured to mate with said adjacent constructional building material.

23. The method of claim 19, further comprising disposing a third constructional building material adjacent to said first constructional building material in a horizontally staggered configuration, wherein said first and third constructional building materials each comprise two end base sections, and an intermediate base section, and at least one vane extending in opposing directions between each of said two end base sections and said intermediate base section to provide a double wide vane that facilitates said horizontally staggered configuration.

24. The method of claim 19, further comprising coupling said first and second constructional building materials with a binding material.

25. The method of claim 24, further comprising forming a complete visual obstruction through said wall system between said first and second constructional building materials, wherein said first constructional building material comprises a vane having a portion that extends beyond its envelope boundary to said envelope boundary of said second constructional building material, said portion extending to conceal a gap formed about said respective vanes, as created by said binding material.

26. A method for facilitating fluid flow through opposing sides of a wall system, said method comprising:
obtaining at least two constructional building materials configured to form at least a part of said wall system, each of said constructional building materials having a base section and a vane extending from said base section; and
positioning said at least two constructional building materials in a manner so as to cause said vanes of said constructional building materials to at least partially define a common volume of space and a fluid flow path that facilitates fluid flow through said opposing sides of said wall system.

27. The method of claim 26, wherein said base sections each include a perimeter surface defining an envelope boundary, and a cross-sectional area of a portion of said vane within said envelope boundary is less than a cross-sectional area of said base section and defines a volume of space about a vane surface and within said envelope boundary.

28. The method of claim 26, wherein positioning said at least two constructional building materials comprises positioning a first of said at least two constructional building materials and a second of said at least two constructional building materials adjacent one another along a vertical axis to relate respective vanes to define, at least in part, said common volume of space and said fluid flow path, wherein a vane of said first constructional building material comprises a configuration different from a configuration of a vane of said second constructional building material.

29. A method for forming at least a portion of a wall system having opposing sides, said method comprising:
obtaining a first constructional building material having at least one base section and at least two vanes extending outward from said base section, said base section of said first constructional building material having a perimeter surface defining an envelope boundary extending along a longitudinal axis, said at least two vanes forming a volume of space;
obtaining a second constructional building material; and
positioning said first and second constructional building materials adjacent one another, wherein said common volume of space defines, at least in part, a fluid flow channel that facilitates fluid flow through said wall system from one of said opposing sides of said wall system to the other of said opposing sides of said wall system along a fluid flow path.

30. The method of claim 29, wherein said second constructional brick comprises a substantially uniform cross-section along a longitudinal axis.
